(19) United States
(12) Patent Application Publication
(10) Pub. No.: US 2020/0407591 A1
(43) Pub. Date: Dec. 31, 2020

(54) AQUEOUS COATING COMPOSITION, MEMBER FOR CAN, AND CAN

(71) Applicants: TOYO INK SC HOLDINGS CO., LTD., Tokyo (JP); TOYOCHEM CO., LTD., Tokyo (JP); Mitsubishi Chemical Corporation, Tokyo (JP)

(72) Inventors: Shoya SATO, Tokyo (JP); Akifumi TOBE, Tokyo (JP); Kou MIYAMA, Tokyo (JP)

(73) Assignees: TOYO INK SC HOLDINGS CO., LTD., Tokyo (JP); TOYOCHEM CO., LTD., Tokyo (JP); Mitsubishi Chemical Corporation, Tokyo (JP)

(21) Appl. No.: 16/980,964

(22) PCT Filed: Apr. 12, 2019
(86) PCT No.: PCT/JP2019/015945

§ 371 Date: Sep. 15, 2020

(30) Foreign Application Priority Data
Apr. 13, 2018 (JP) 2018-077723
Nov. 26, 2018 (JP) 2018-220430

(51) Int. Cl. C09D 163/00; B65D 25/14; B65D 65/42

(52) U.S. Cl. CPC C09D 163/00; B65D 65/42; B65D 25/14

(57) ABSTRACT

An aqueous coating composition which does not contain any epoxy resin having a bisphenol skeleton or a biphenol skeleton, such as BPA, as a raw material, and can be formed into a coating film which has reduced adsorption of flavor odor components in can contents and has high retort resistance and processability. The aqueous coating composition includes a composite resin and water, where the composite resin includes a moiety of an epoxy resin and a moiety of a carboxyl group-containing acrylate copolymer, and the epoxy resin forming the moiety of the epoxy resin is a reaction product of an epoxy group in an epoxy compound not having any one of a bisphenol skeleton and a biphenol skeleton with a carboxyl group in a carboxyl group-containing polyester, the reaction product having an epoxy group.

### TECHNICAL FIELD

The present disclosure relates to an aqueous coating composition, a member for a can, and a can.

### BACKGROUND ART

Metal cans are usually coated with thin protective coating films made of synthetic resins to prevent direct contact of their contents with metal materials such as tinplate, tin-free steel, and aluminum and thus prevent corrosion of the metal materials. One of known aqueous coating compositions for coating inner surfaces includes a coating composition prepared by dissolving or dispersing a so-called self-emulsifiable bisphenol epoxy resin, where a bisphenol epoxy resin and an acrylic resin are partially bonded, and a phenol resin in an aqueous medium.

Here, as the coating for inner surfaces of cans, there is a demand for a coating film which has flavor loss resistance not imparting flavors of contents, anticorrosion, and retort resistance, and has high processability enabling processes during molding of can members.

Patent Literature 1 discloses an aqueous coating composition comprising an emulsifiable bisphenol epoxy resin (A) and a phenol resin (D) which are dispersed in an aqueous medium in the presence of amine or ammonia. According to Patent Literature 1, a coating film of the aqueous coating composition can form a coating which prevents adsorption of flavor odor components in alcohol beverages, has high anticorrosion against alcohol beverages containing sulfites, and can have high processability.

On the other hand, an aqueous coating composition not containing a bisphenol A (BPA) epoxy resin has been examined as a coating for a can.

As a method not using a bisphenol epoxy resin, for example, Patent Literature 2 discloses an aqueous coating composition for inner surfaces of specific cans comprising an acrylic modified polyester resin prepared through graft polymerization of a specific unsaturated monomer having a carboxyl group to a polyester resin containing an ethylenically unsaturated bond.

As another method, there is an aqueous coating composition comprising an emulsion type acrylic resin synthesized by emulsion polymerization. Usually, a surfactant is used as an emulsifier in emulsion polymerization, and the retort resistance is worsened because of influences from the residual surfactant in a coating film formed from the coating, causing problems such as whitening and blister (peel off in the form of dots) of the coating film. For example, Patent Literature 3 discloses an aqueous resin composition for a can coating containing a specific soap-free acrylic resin emulsion not including a surfactant.

### CITATION LIST

### Patent Literature

Patent Literature 1: Japanese Unexamined Patent Application Publication No. 2006-36964

Patent Literature 2: Japanese Unexamined Patent Application Publication No. 2002-302639

Patent Literature 3: Japanese Unexamined Patent Application Publication No. 2002-155234

### SUMMARY OF INVENTION

### Technical Problem

However, the coating composition for can inner surfaces according to Patent Literature 2 has insufficient retort resistance. Moreover, the emulsion type acrylic resin disclosed in Patent Literature 3 and the like usually has a problem that flavor odor components in can contents are readily adsorbed by the coating film.

The present disclosure has been made in consideration of such circumstances. An object of the present disclosure is to provide an aqueous coating composition which does not contain any epoxy resin having a bisphenol skeleton or a biphenol skeleton, such as BPA, as a raw material, and can be formed into a coating film which has reduced adsorption of flavor odor components in can contents and has high retort resistance, and a coated can including a coating film of the aqueous coating composition.

### Solution to Problem

One embodiment of the aqueous coating composition according to the present disclosure is an aqueous coating composition comprising a composite resin (C) and water,

wherein the composite resin (C) includes a moiety of an epoxy resin (A) and a moiety of a carboxyl group-containing acrylate copolymer (B), and

the epoxy resin (A) forming the moiety of the epoxy resin (A) is a reaction product of an epoxy group in an epoxy compound not having any of a bisphenol skeleton and a biphenol skeleton with a carboxyl group in a polyester having a carboxyl group, the reaction product having an epoxy group.

One embodiment of the member for a can according to the present disclosure includes a coating film of the aqueous coating composition according to the present disclosure on a surface of a can substrate.

One embodiment of the can according to the present disclosure is a can comprising a plurality of members for a can which form the can, the plurality of members for a can at least partially including a member for a can according to the present disclosure.

### Advantageous Effects of Invention

The present disclosure can provide an aqueous coating composition which does not contain any epoxy resin having a bisphenol skeleton or a biphenol skeleton, such as BPA, and can be formed into a coating film which has reduced adsorption of flavor odor components in can contents and has high retort resistance, and a can including a coating film of the aqueous coating composition.

### BRIEF DESCRIPTION OF THE DRAWINGS

FIG. 1 is a schematic view showing one embodiment of a can.

FIG. 2A is a schematic view illustrating a process of preparing a test piece for a processability test, in which a test panel (Test piece 1) before bending is shown.

FIG. 2B is a schematic view illustrating the process of preparing a test piece for a processability test, in which the test panel (Test piece 1) is bend to form Test piece 3.

FIG. 2C is a schematic view illustrating the process of preparing a test piece of a processability test, in which a weight is dropped onto Test piece 3.

### DESCRIPTION OF EMBODIMENTS

The aqueous coating composition and the can according to the present disclosure will now be described.

In the present disclosure, the monomer is an ethylenically unsaturated monomer. Moreover, (meth)acrylic acid includes acrylic acid and methacrylic acid, and (meth)acrylate includes acrylate and methacrylate.

In the present disclosure, (iso)alkylether includes normal alkylether (n-alkylether) and isoalkylether (alkyl is substituted by a specific alkyl group such as propyl and butyl in some cases).

The coating film according to the present disclosure indicates a coating film formed by applying the aqueous coating composition onto a substrate such as a metal plate.

In the present disclosure, the bisphenol skeleton indicates a skeleton represented by the following structural formula (1). In the structural formula (1), Rs each independently represent a hydrogen atom or an organic group. In the present disclosure, the biphenol skeleton indicates a skeleton represented by the following structural formula (2).

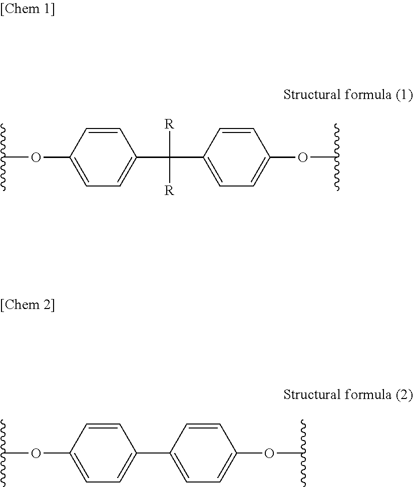

### Aqueous Coating Composition

The aqueous coating composition according to the present disclosure is an aqueous coating composition comprising a composite resin (C) and water,

wherein the composite resin (C) includes a moiety of an epoxy resin (A) and a moiety of a carboxyl group-containing acrylate copolymer (B), and

the epoxy resin (A) forming the moiety of the epoxy resin (A) is a reaction product of an epoxy group in an epoxy compound not having any of a bisphenol skeleton and a biphenol skeleton and a carboxyl group in a polyester having a carboxyl group, the reaction product having an epoxy group.

The composite resin (C) indicates a resin where at least part of the moiety of the epoxy resin (A) are bonded to at least part of the acrylate copolymer (B), rather than a simple mixture.

Although the details will be described later, for the composite resin (C), the acrylate copolymer (B) can be reacted with the epoxy resin (A) to prepare a bonded product thereof, or the epoxy resin (A) can be reacted with an acrylate monomer for forming the moiety of the acrylate copolymer (B) to prepare a bonded product thereof.

The aqueous coating composition according to the present disclosure, which comprises the composite resin (C) containing the moiety of the epoxy resin (A) having a polyester structure and the moiety of the acrylate copolymer (B), can be formed into a coating film which has reduced adsorption of flavor odor components and has high retort resistance and processability.

### Epoxy Resin (A)

In the present disclosure, the epoxy resin (A) is a reaction product of an epoxy compound not having any of a bisphenol skeleton and a biphenol skeleton with a polyester.

### Epoxy Compound

The epoxy compound is a compound having one or more oxirane ring structures in the molecule. As the oxirane ring structure, a glycidyl group is preferred. The epoxy compound in the present disclosure is an epoxy compound not having any of a bisphenol skeleton and a biphenol skeleton. Hereinafter, the epoxy compound not having any of a bisphenol skeleton and a biphenol skeleton may be abbreviated to an epoxy compound not having a bisphenol skeleton and the like in some cases.

Such an epoxy compound preferably has a unit selected from the group consisting of linear hydrocarbon units, oxyalkylene units, cyclic hydrocarbon units, and heterocycle units other than an epoxy group, and two or more glycidyl groups. Because a coating film having high processability and moisture resistance can be formed, the epoxy compound preferably has a cyclic hydrocarbon unit or a heterocycle unit other than an epoxy group, and two glycidyl groups in the molecule. Because a coating film having higher process ability can be formed, the epoxy compound preferably has a linear hydrocarbon unit, and two glycidyl groups in the molecule.

The linear hydrocarbon units are linear or branched hydrocarbon units.

The linear hydrocarbon units are preferably alkylenes having 1 to 20 carbon atoms. Examples of the alkylenes having 1 to 20 carbon atoms include methylene, ethylene, propylene, pentylene, hexylene, and decylene.

The branched hydrocarbon units are preferably units having a C₁ to C₂₀ alkylene group in the main chain and a C₁ to C₄ alkyl group in the side chain. The branched hydrocarbon units preferably have one or more side chains in the main chain.

Examples of the oxyalkylene units include (poly)oxyethylene, (poly)oxypropylene, and (poly)oxytetramethylene groups.

The cyclic hydrocarbon units are preferably a ring structure having 5 to 6 carbon atoms. Examples of the ring structure having 5 to 6 carbon atoms include a cyclopentyl group, a cyclohexyl group, and a phenyl group.

The cyclic hydrocarbon units may be a structure having two ring structures having 5 to 6 carbon atoms, such as decalin. The cyclic hydrocarbon units may have the linear hydrocarbon unit as a substituent.

Examples of a heteroatom forming a heterocycle other than an epoxy group include oxygen, nitrogen, and sulfur atoms. Among these, the oxygen atom is preferred.

Examples of the heterocycle units other than an epoxy group include furan, tetrahydrofuran, thiophene, tetrahydrothiophene, pyrrole, pyrrolidine, oxazole, imidazole, pyridine, piperidine, tetrahydropyran, dioxane, and dioxolane.

The heterocycle units may be a structure having two heterocycle structures, such as purine. The heterocycle units may have the linear hydrocarbon unit as a substituent.

Use of an epoxy compound containing the linear hydrocarbon unit enhances the processability of the coating film, compared to use of an epoxy compound containing the cyclic hydrocarbon unit. Use of an epoxy compound containing the cyclic hydrocarbon unit enhances the moisture resistance of the coating film, compared to use of an epoxy compound containing the linear hydrocarbon unit.

Among preferred epoxy compounds, examples of the epoxy compound containing the linear hydrocarbon unit include

epoxy compounds prepared from a variety of carboxylic acids such as adipic acid, succinic acid, and phthalic acid, and epihalohydrin; and

(poly)alkylene glycol diglycidyl ethers such as ethylene glycol diglycidyl ether, propylene glycol diglycidyl ether, 1,4-butanediol diglycidyl ether, 1,5-pentanediol diglycidyl ether, 1,6-hexanediol diglycidyl ether, 1,7-heptanediol diglycidyl ether, 1,8-octanediol diglycidyl ether, 1,10-decanediol diglycidyl ether, and 2,2-dimethyl-1,3-propanediol diglycidyl ether.

Among the preferred epoxy compounds, examples of the epoxy compounds containing the oxyalkylene units include diethylene glycol diglycidyl ether, triethylene glycol diglycidyl ether, polyethylene glycol diglycidyl ether, tripropylene glycol diglycidyl ether, polypropylene glycol diglycidyl ether, polytetramethylene glycol diglycidyl ether, polypentamethylene glycol diglycidyl ether, polyheptamethylene glycol diglycidyl ether, and polyhexamethylene glycol diglycidyl ether.

Among the preferred epoxy compounds, examples of the epoxy compounds containing the cyclic hydrocarbon units include epoxy compounds having an aromatic ring of diglycidyl ether to which hydrogen is added, the diglycidyl ether being selected from bisphenol diglycidyl ethers, biphenol diglycidyl ethers, benzenediol diglycidyl ethers, and aromatic diglycidyl ethers;

epoxy compounds prepared from a variety of carboxylic acids, such as tetrahydrophthalic acid, methylhexahydrophthalic acid, terephthalic acid, isophthalic acid, orthophthalic acid, and dimer acid, and epihalohydrin;

alkylene glycol diglycidyl ethers having a cyclic structure such as 1,4-cyclohexanedimethanol diglycidyl ether; and

aromatic diglycidyl ethers such as hydroquinone diglycidyl ether, resorcinol diglycidyl ether, and catechol diglycidyl ether.

Among the preferred epoxy compounds, examples of the epoxy compound containing the unit selected from the heterocycle units other than an epoxy group include isosorbide diglycidyl ether.

### Polyester

The polyester is a polymerized product of a polyvalent carboxylic acid and a polyhydric alcohol. The polyester is a raw material which reacts with the epoxy compound above to form the epoxy resin (A), and therefor has a carboxyl group. It is preferred that the polyester do not have any of a bisphenol skeleton and a biphenol skeleton as in the epoxy compound. The polyester is prepared, for example, through dehydration condensation of a carboxyl group in a polyvalent carboxylic acid and a hydroxyl group in a polyhydric alcohol.

It is sufficient that the polyvalent carboxylic acid is a compound having two or more carboxylic acids in the molecule. Among these, preferred are compounds having 2 or more and 4 or less carboxylic acids in the molecule, and more preferred are dicarboxylic acids having two carboxylic acids in the molecule.

Specific examples of the dicarboxylic acids include aromatic dicarboxylic acids such as terephthalic acid, isophthalic acid, orthophthalic acid, and naphthalene dicarboxylic acid; alicyclic dicarboxylic acids such as 1,4-cyclohexanedicarboxylic acid, 1,3-cyclohexanedicarboxylic acid, and 1,2-cyclohexanedicarboxylic acid; aliphatic dicarboxylic acids such as adipic acid, sebacic acid, succinic acid, azelaic acid, and dodecanedionic acid; α, β-unsaturated dicarboxylic acids such as fumaric acid, maleic acid, itaconic acid, and citraconic acid; and acid anhydrides thereof.

These polyvalent carboxylic acids can be used alone or in combination.

It is sufficient that the polyhydric alcohol is a compound having two or more hydroxyl groups in the molecule. Among these, preferred are compounds having 2 or more and 4 or less hydroxyl groups in the molecule, and more preferred are diols having two hydroxyl groups in the molecule.

Specific examples of the diols include aliphatic diols such as ethylene glycol, 1,2-propanediol, 1,3-propanediol, 1,4-butanediol, 1,3-butanediol, 1,2-butanediol, 1,5-pentanediol, 1,6-hexanediol, 1,9-nonanediol, 2-methyl-1,3-propanediol, neopentyl glycol, 2-ethyl-2-butyl-1,3-propanediol, and 3-methyl-1,5-pentanediol; alicyclic diols such as 1,4-cyclohexanedimethanol; and diols containing ether bonds, such as diethylene glycol, triethylene glycol, dipropylene glycol, polyethylene glycol, polypropylene glycol, and polytetramethylene glycol.

These polyhydric alcohols can be used alone or in combination.

Although not particularly limited, the hydroxyl value of the polyester is preferably 0.001 mgKOH/g or more, more preferably 0.005 mgKOH/g or more, particularly preferably 0.01 mgKOH/g or more from the viewpoint of availability of raw materials. The hydroxyl value of the polyester is preferably 60 mgKOH/g or less, more preferably 50 mgKOH/g or less, particularly preferably 40 mgKOH/g or less to improve the flexibility.

Although not particularly limited, the acid value of the polyester is preferably 10 mgKOH/g or more, more preferably 15 mgKOH/g or more, particularly preferably 20 mgKOH/g or more from the viewpoint of handling during synthesis. The acid value is preferably 200 mgKOH/g or less, more preferably 175 mgKOH/g or less, particularly preferably 150 mgKOH/g or less to improve the flexibility.

Although not particularly limited, the mass average molecular weight (Mw) of the polyester is preferably 500 or more, more preferably 750 or more, particularly preferably 1,000 or more to improve the flexibility. The mass average molecular weight (Mw) is preferably 10,000 or less, more preferably 9,000 or less, particularly preferably 8,000 or less from the viewpoint of handling during synthesis.

In the present disclosure, the number average molecular weight and mass average molecular weight are measured by GPC (in terms of polystyrene standards).

In the present disclosure, the polyester is prepared through polycondensation of the polyvalent carboxylic acid and the polyhydric alcohol. The reaction temperature and the reaction time can be appropriately adjusted to prepare a polyester having a predetermined number average molecular weight.

In the present disclosure, the polyester has a carboxyl group, and more preferably has a carboxyl group in the molecular terminals.

### Synthesis of Epoxy Resin (A)

The reaction of the epoxy compound with the polyester can also be performed under any condition of normal pressure, increased pressure, and reduced pressure.

The reaction temperature is usually 60 to 240° C., preferably 80 to 220° C., more preferably 100 to 200° C. A reaction temperature equal to or more than the lower limit is preferred because the reaction readily progresses. A reaction temperature less than or equal to the upper limit is preferred because a side reaction hardly progresses and a high purity epoxy resin is obtained.

Although not particularly limited, the reaction time is usually 0.5 to 24 hours, preferably 1 to 22 hours, more preferably 1.5 to 20 hours. A reaction time less than or equal to the upper limit is preferred to improve the production efficiency, and a reaction time equal to or more than the lower limit is preferred to reduce unreacted components.

In the present disclosure, a catalyst may be used in a reaction step to prepare the epoxy resin (A). The catalyst can be any catalyst usually used for an advance method in a method of preparing an epoxy resin.

In the present disclosure, for the compounding ratio of the epoxy compound and the polyester used in preparation of the epoxy resin (A), the theoretical epoxy equivalent of the resulting epoxy resin is preferably 200,000 g/equivalent or less, more preferably 150,000 g/equivalent or less, particularly preferably 100,000 g/equivalent or less to ensure the miscibility with other materials. A preferred lower limit of the theoretical epoxy equivalent is more than 100 g/equivalent, 120 g/equivalent or more, particularly 150 g/equivalent or more, especially 200 g/equivalent or more because an epoxy resin having high flexibility can be prepared.

Here, the theoretical epoxy equivalent means the epoxy equivalent in the reaction product when all the epoxy groups contained in in the epoxy compound and all the carboxyl groups contained in the polyester are reacted at a ratio of 1:1.

The epoxy equivalent of the epoxy resin (A) is preferably 200 or more and 200,000 or less, more preferably 250 or more and 100,000 or less, particularly preferably 300 or more and 50,000 or less.

An epoxy equivalent equal to or more than the lower limit results in a coating film having higher processability and anticorrosion. At an epoxy equivalent less than or equal to the upper limit, the reaction with the moiety of the acrylate copolymer (B) described later readily progresses, resulting in high dispersion stability of the composite resin in the aqueous coating composition.

The epoxy resin (A) has a mass average molecular weight of preferably 7,000 or more and 200,000 or less, more preferably 7,100 or more and 150,000 or less, particularly preferably 7,200 or more and 100,000 or less.

If the mass average molecular weight is equal to or more than the lower limit, the resulting coating film has high processability, and cracks of the coating film in the lids and their seams can be prevented when the aqueous coating composition is used as a coating for the inner surface of a can body, enhancing the anticorrosion of the can. If the mass average molecular weight is less than or equal to the upper limit, the viscosity of the aqueous coating composition is not significantly increased, and can be adjusted to a viscosity suitable for application.

### Moiety of the Acrylate Copolymer (B)

In the present disclosure, the moiety of a carboxyl group-containing acrylate copolymer (B) comprises at least a carboxyl group-containing monomer as a copolymerization component, and further may contain other ethylenically unsaturated monomers as needed.

In the present disclosure, the carboxyl group-containing monomer has at least an ethylenically unsaturated bond and a carboxyl group.

Examples of the ethylenically unsaturated bond include a vinyl group, an allyl group, and a (meth)acryloyl group.

Specific examples of the carboxyl group-containing monomer include (meth)acrylic acid, maleic acid (anhydride), itaconic acid, and fumaric acid. Among these, it is preferred that (meth)acrylic acid be contained.

The carboxyl group-containing monomers can be used alone or in combination.

Examples of the other ethylenically unsaturated monomers include, but should not be limited to, alkyl (meth)acrylate ester monomers such as methyl (meth)acrylate, ethyl (meth)acrylate, isopropyl (meth)acrylate, n-propyl (meth)acrylate, n-butyl (meth)acrylate, isobutyl (meth)acrylate, t-butyl (meth)acrylate, hexyl (meth)acrylate, and 2-ethylhexyl (meth)acrylate;

ethylenically unsaturated monomers having a hydroxyl group such as hydroxymethyl (meth)acrylate, 2-hydroxyethyl (meth)acrylate, 2-hydroxypropyl (meth)acrylate, 4-hydroxybutyl (meth)acrylate, hydroxypentyl (meth)acrylate, and hydroxyhexyl (meth)acrylate;

styrene monomers such as styrene, vinyltoluene, 2-methylstyrene, t-butylstyrene, and chlorostyrene; and

amide monomers such as N-hydroxyalkyl(meth)acrylamides (such as N-hydroxymethyl(meth)acrylamide, N-hydroxyethyl(meth)acrylamide, and N-hydroxybutyl(meth)acrylamide), N-alkoxyalkyl(meth)acrylamides (such as N-methoxymethyl(meth)acrylamide, N-ethoxymethyl(meth)acrylamide, N-(n-, iso)butoxymethyl(meth)acrylamide, N-methoxyethyl(meth)acrylamide, N-ethoxyethyl(meth)acrylamide, N-(n-, iso)butoxyethyl(meth)acrylamide), and (meth)acrylamide.

As the other ethylenically unsaturated monomers, preferred is use of acrylic acid alkyl ester monomers or styrene monomers. Among these, methyl (meth)acrylate, ethyl (meth)acrylate, n-butyl (meth)acrylate, isobutyl (meth)acrylate, t-butyl (meth)acrylate, 2-ethylhexyl (meth)acrylate, 2-hydroxyethyl (meth)acrylate, and styrene are more preferred.

These other ethylenically unsaturated monomers can be used alone or in combination.

The composition of the moiety of the carboxyl group-containing acrylic copolymer (B) contains preferably 30 to 70% by mass, more preferably 40 to 70% by mass of the carboxyl group-containing monomer.

A proportion of the carboxyl group-containing monomer within this lower limit or higher results in a composite resin (C) having improved hydrophilicity, thus having further enhanced dispersion stability in the aqueous coating composition. A proportion of the carboxyl group-containing monomer within this upper limit or less avoids a significantly high proportion of the carboxyl group in the copolymer (B), resulting in compatibility between hydrophilicity and moisture resistance, reducing a non-homogeneous reaction with the epoxy resin, and suppressing gelation during the reaction. Moreover, the viscosity of the resulting coating composition is reduced, and the viscosity is highly stable over time.

In the method of polymerizing the moiety of the carboxyl group-containing acrylic copolymer (B), an azobispolymerization initiator or a peroxide polymerization initiator can be appropriately used according to a normal method.

Examples of the azobispolymerization initiator include azobisisobutyronitrile, azobismethylbutyronitrile, azobis-(2,4-dimethylvaleronitrile), and 2,2′-azobis-(4-methoxy-2,4-dimethylvaleronitrile).

Examples of the peroxide polymerization initiator include tert-butyl hydroperoxide, cumene hydroperoxide, di-tert-butyl peroxide, benzoyl peroxide (benzoyl peroxide), diisopropyl peroxydicarbonate, and tert-butyl peroxybenzoate.

Any organic solvent can be used in the reaction step without limitation. Preferred are solvents having relatively high hydrophilicity shown below.

Specifically, the following organic solvents can be appropriately used: alcohols such as ethanol, n-propanol, isopropanol, n-butyl alcohol, isobutyl alcohol, n-amyl alcohol, amyl alcohol, methylamyl alcohol, octanol, and 2-ethylhexanol;

glycols such as ethylene glycol, diethylene glycol, propylene glycol, dipropylene glycol, and 1,3-butylene glycol;

a variety of ether alcohols or ethers such as ethylene glycol monomethyl ether, ethylene glycol dimethyl ether, ethylene glycol monoethyl ether, ethylene glycol diethyl ether, ethylene glycol mono(iso)propyl ether, ethylene glycol di(iso)propyl ether, ethylene glycol mono(iso)butyl ether, ethylene glycol di(iso)butyl ether, ethylene glycol mono-tert-butyl ether, ethylene glycol monohexyl ether, 1,3-butylene glycol-3-monomethyl ether, 3-methoxybutanol, 3-methyl-3-methoxybutanol, diethylene glycol monomethyl ether, diethylene glycol dimethyl ether, diethylene glycol monoethyl ether, diethylene glycol diethyl ether, diethylene glycol mono(iso)propyl ether, diethylene glycol di(iso)propyl ether, diethylene glycol mono(iso)butyl ether, diethylene glycol di(iso)butyl ether, diethylene glycol monohexyl ether, diethylene glycol dihexyl ether, triethylene glycol dimethyl ether, propylene glycol monomethyl ether, propylene glycol monoethyl ether, propylene glycol mono(iso)propyl ether, propylene glycol mono(iso)butyl ether, propylene glycol dimethyl ether, propylene glycol diethyl ether, propylene glycol di(iso)propyl ether, propylene glycol di(iso)butyl ether, dipropylene glycol monomethyl ether, dipropylene glycol monoethyl ether, dipropylene glycol mono(iso)propyl ether, dipropylene glycol mono(iso)butyl ether, dipropylene glycol dimethyl ether, dipropylene glycol diethyl ether, diethylene glycol di(iso)propyl ether, dipropylene glycol di(iso)butyl ether; and

acetates such as ethylene glycol monomethyl ether acetate, ethylene glycol monoethyl ether acetate, propylene glycol monomethyl ether acetate, 3-methoxybutyl acetate, ethylene glycol monobutyl ether acetate, and 3-methyl-3-methoxybutyl acetate. These solvent may be separately added after the reaction as needed.

### Composite Resin (C)

The aqueous coating composition according to the present disclosure comprises the composite resin (C) including the moiety of the epoxy resin (A) and the moiety of the acrylate copolymer (B).

Although the composite resin (C) can be synthesized by any method, the following three methods will be described. According to the first and second methods described later, an epoxy⋅acrylic composite resin can be suitably prepared, where the moiety of the epoxy resin (A) is bonded to the moiety of the acrylate copolymer (B) through an oxyester bond and the composite resin (C) has the moiety of the acrylate copolymer (B) in at least one of terminals of the moiety of the epoxy resin (A). The epoxy⋅acrylic composite resin may be a block polymer composed of a moiety of the epoxy resin (A)—a moiety of the acrylate copolymer (B)—a moiety of the epoxy resin (A).

According to the third method described later, a graft polymer can be suitably prepared where the moiety of the acrylate copolymer (B) is graft bonded to a secondary or tertiary carbon of the moiety of the epoxy resin (A) and the composite resin (C) has the moiety of the acrylate copolymer (B) in a side chain of the moiety of the epoxy resin (A).

The oxyester bond is a bond generated through an esterification reaction, which is an addition reaction between a carboxyl group and a glycidyl group, the bond having a structure represented by:

—COO—CR¹R²—CR³(OH)—

(where R¹, R², and R³ each independently a hydrogen atom or an organic group).

### First Method

First, a first method (esterification) of synthesizing the composite resin (C) will be described. In a composite resin (C-1) prepared by the first method, the moiety of the epoxy resin (A) not having a bisphenol skeleton and the like is bonded to the moiety of the carboxyl group-containing acrylic copolymer (B) through an oxyester bond.

In the first method, the composite resin (C) is synthesized through an esterification reaction of part of carboxyl groups in the carboxyl group-containing acrylic copolymer (B), which is preliminarily prepared, with the glycidyl groups in the epoxy resin (A) not having a bisphenol skeleton and the like.

During preparation of the composite resin (C-1), the proportion or mass ratio of the epoxy resin (A) to the acrylic copolymer (B) is preferably 60/40 to 90/10, more preferably 65/35 to 85/15.

A proportion of the acrylic copolymer (B) of 60/40 or less facilitates progression of the esterification reaction between the epoxy resin (A) and the acrylic copolymer, and results in a composite resin (C-1) having high dispersion stability in the aqueous coating composition. A proportion of the acrylic copolymer (B) of 60/40 or less prevents excessively high hydrophilicity, and results in a coating film having high moisture resistance.

In contrast, a proportion of the acrylic copolymer (B) of 90/10 or higher results in a composite resin (C-1) having sufficient hydrophilicity and having high dispersion stability in the aqueous coating composition so that the composite resin (C-1) barely sediments over time.

Preferred esterification catalysts used in esterification are organic amine compounds, ammonia, and hydroxides of alkali metals.

Examples of the organic amine compounds include monomethylamine, dimethylamine, trimethylamine, monoethylamine, diethylamine, triethylamine, monopropylamine, dipropylamine, monoethanolamine, diethanolamine, triethanolamine, N,N-dimethyl-ethanolamine, N,N-diethyl-ethanolamine, 2-dimethylamino-2-methyl-1-propanol, 2-amino-2-methyl-1-propanol, N-methyldiethanolamine, N-ethyldiethanolamine, monoisopropanolamine, diisopropanolamine, and triisopropanolamine.

Examples of the hydroxides of alkali metals include lithium hydroxide, sodium hydroxide, and potassium hydroxide.

These basic compounds can be used alone or in combination.

The content of the esterification catalyst is preferably 1 to 80 mol %, more preferably 5 to 60 mol % relative to 100 mol % of the carboxyl group-containing monomer. The reaction conditions to be used during the esterification reaction such as the temperature and the time are known conditions, rather than special ones.

The composite resin (C-1) prepared above can be prepared into an aqueous dispersion in the same manner as in a normal method of water dispersing an acrylic modified epoxy resin. Specifically, examples thereof include a method of neutralizing carboxyl groups present in the composite resin (C-1) with a basic compound to impart hydrophilicity thereto. More specifically, examples thereof include a method of adding a basic compound to the composite resin (C-1), and then adding an aqueous medium to prepare an aqueous dispersion, and a method of adding an aqueous medium containing a basic compound to the composite resin (C-1) to prepare an aqueous dispersion.

Preferred basic compounds used in neutralization of carboxyl groups present in the composite resin (C-1) are organic amine compounds, ammonia, hydroxides of alkali metals.

Examples of the organic amine compounds include monomethylamine, dimethylamine, trimethylamine, monoethylamine, diethylamine, triethylamine, monopropylamine, dipropylamine, monoethanolamine, diethanolamine, triethanolamine, N,N-dimethyl-ethanolamine, N,N-diethyl-ethanolamine, 2-dimethylamino-2-methyl-1-propanol, 2-amino-2-methyl-1-propanol, N-methyldiethanolamine, N-ethyldiethanolamine, monoisopropanolamine, diisopropanolamine, and triisopropanolamine.

Examples of the hydroxides of alkali metals include lithium hydroxide, sodium hydroxide, and potassium hydroxide.

These basic compounds can be used alone or in combination.

The aqueous medium in the present disclosure is a mixture of water and a hydrophilic solvent. The content of water is at least 50% by mass or more, preferably 70% by mass or more, more preferably 80% by mass or more in the entire aqueous medium. Examples of the hydrophilic solvent includes those listed in preparation of the carboxyl group-containing acrylic copolymer (B) above.

### Second Method

A second method (a direct method (also referred to as esterification)) of synthesizing the composite resin (C) will be described. In the composite resin (C-2) prepared by the second method, the moiety of the epoxy resin (A) not having a bisphenol skeleton and the like is bonded to the moiety of the carboxyl group-containing acrylic copolymer (B) through an oxyester bond.

The composite resin (C-2) according to the second aspect is synthesized as follows: glycidyl groups in the epoxy resin (A) not having a bisphenol skeleton and the like are reacted with the carboxyl group-containing monomer (b1) to arrange an ethylenically unsaturated group at terminals of the epoxy resin (A), and then the resulting ethylenically unsaturated monomer containing a carboxyl group-containing monomer for forming a moiety of the acrylic copolymer (B) is copolymerized.

The esterification catalysts already described can be used as the esterification catalyst used in the reaction between the epoxy resin (A) not having a bisphenol skeleton and the like and the carboxyl group-containing monomer (b1).

The polymerization initiators already described can be used as the polymerization initiator used in copolymerization of the epoxy resin (A) having an ethylenically unsaturated group with the ethylenically unsaturated monomer.

The organic solvents already described can be used as the organic solvent used in the second method.

Although the synthetic process is different from that in the first method, as a result, similarly to the composite resin (C-1), the composite resin (C-2) can be formed where the moiety of the epoxy resin (A) not having a bisphenol skeleton and the like and the moiety of the acrylic copolymer (B) prepared through copolymerization of the carboxyl group-containing monomer as the essential component are bonded through an oxyester bond.

Accordingly, the mass ratio of the moiety of the epoxy resin (A) not having a bisphenol skeleton and the like to the radically polymerizable monomer which form the composite resin (C-2) is preferably the same as that in the first method. Specifically, the mass ratio (A)/[(b1)+(b2)] of the epoxy resin (A) not having a bisphenol skeleton and the like to the total amount (b1)+(b2) of the carboxyl group-containing monomer (b1) used in esterification and the ethylenically unsaturated monomer (b2) used in copolymerization is preferably 60/40 to 90/10, more preferably 65/35 to 85/15. For the moieties derived from the ethylenically unsaturated monomer, the proportion of the carboxyl group-containing monomer in the ethylenically unsaturated monomer is preferably 30 to 70% by mass, more preferably 40 to 70% by mass.

### Third Method

A third method (grafting) of synthesizing the composite resin (C) will be described. In the composite resin (C-3) prepared by the third method, the moiety of the acrylate copolymer (B) is graft bonded to the methylene unit of the epoxy resin (A).

The composite resin (C-3) is synthesized by grafting an ethylenically unsaturated monomer containing a carboxyl group-containing monomer to the epoxy resin (A) in the presence of a free radical generator. Generally, accompanied by the hydrogen drawing reaction, radicals are generated in secondary and tertiary carbons of the epoxy resin (A), and from these carbons, polymerization of a radical polymerizable monomer or the reaction with growth terminals of its copolymer occurs to form an acrylic polymer. In other words, graft polymerization is performed to generate the moiety of the carboxyl group-containing acrylic copolymer (B) bonded to the moiety of the epoxy resin (A) not having a bisphenol skeleton and the like.

In the present disclosure, the graft bond indicates the thus-formed bond between a carbon atom in the moiety of the epoxy resin (A) not having a bisphenol skeleton and the like and the carbon atom in the moiety of the carboxyl group-containing acrylic copolymer (B).

For the free radical generator, among the polymerization initiators listed in preparation of the moiety of the acrylic copolymer (B), peroxides are suitable, and benzoyl peroxide is particularly preferred.

The organic solvents already described can be used as the organic solvent used in the graft reaction.

The reaction conditions to be used during the graft reaction, such as the temperature and the time, are known conditions, rather than special ones.

Unlike the processes according to the first and second aspects, in the process of preparing the composite resin (C-3) by the third method, the moiety of the epoxy resin (A) is bonded to the moiety of the acrylic copolymer (B) through a graft bond to form a composite resin.

It is preferred that the mass ratio of the moiety of the epoxy resin (A) forming the composite resin (C-3) prepared by the third method to the moiety derived from the ethylenically unsaturated monomer be the same as those in the composite resins (C) according to the first and second aspects. Specifically, the mass ratio (A)/(c) of the epoxy resin (A) to the ethylenically unsaturated monomer (c) containing the carboxyl group-containing monomer is preferably 60/40 to 90/10 (mass ratio), more preferably 65/35 to 85/15.

The proportion of the carboxyl group-containing monomer in 100% by mass of the ethylenically unsaturated monomer forming the moiety of the carboxyl group-containing acrylic copolymer (B) is preferably 30 to 70% by mass, more preferably 40 to 70% by mass.

In the first or second method, the free radical generator may be added to perform the graft polymerization simultaneously or in two stages. In the third method, an esterification catalyst may be added to oxyester bond the carboxyl group-containing monomer to glycidyl groups of the epoxy resin (A).

These methods can prepare composite resins (C) where the moiety of the acrylic copolymer (B) is formed in terminals and side chains of the moiety of the epoxy resin (A).

### Other Components

The aqueous coating composition according to the present disclosure usually contains a medium for dispersing the composite resin (C), such as water, and may further contain other optional components in the range not impairing the effects. The components which can be suitably contained will now be described.

### Hydrophilic Organic Solvent

The aqueous coating composition according to the present disclosure usually contains water, and may further contain an optional hydrophilic organic solvent. If the hydrophilic organic solvent is contained, for example, application properties can be improved. Although any hydrophilic solvent can be used, the same as those listed as the solvents used in synthesis of the moiety of the acrylic copolymer (B) is preferably used.

These hydrophilic organic solvents can be used alone or in combination.

To enhance the curability of the coating film and the adhesion to the metal, as needed, the aqueous coating composition according to the present disclosure can further contain a curing agent (D). As the curing agent (D), a phenol resin, an amino resin, β-hydroxyalkylamide, or tris(alkoxycarbonylamino)triazine can be used, and these curing agents (D) can be used alone or in combination.

The curing agent (D) can undergo a self cross-linking reaction, and can react with carboxyl groups in the composite resin (C). If the composite resin (C) has hydroxyl groups, the curing agent (D) can also react with these hydroxyl groups. Furthermore, if other ethylenically unsaturated monomers forming the moiety of the acrylate copolymer (B) contain an amide monomer and the composite resin (C) has cross-linkable functional groups derived from the amide monomer, the curing agent (D) can also react with these cross-linkable functional groups.

Examples of the phenol resin include resins synthesized through an addition condensation reaction between a phenol compound and an aldehyde such as formaldehyde.

Examples of the phenol compound include phenol, o-cresol, p-cresol, m-cresol, p-tert-butylphenol, p-phenylphenol, p-nonylphenol, 2,3-xylenol, 2,5-xylenol, 3,5-xylenol, catechol, resorcinol, and hydroquinone. In this case, these phenol compounds may be used alone or in combination.

The phenol resin to be used may be a commercially available product. Examples of commercially available products preferably used include Phenodurs PR285, PR516, PR566, PR612, VPR1785 available from Allnex; SUMILITE resins PR-55317, PR-55819, and PR-53893A available from Sumitomo Bakelite Co., Ltd.; and Shownols BKS-368 and CKS-3898 available from Aica SDK Phenol CO., Ltd.

Examples of the amino resin include those prepared through an addition reaction of formaldehyde with amino compounds such as urea, melamine, and benzoguanamine. In this case, these amino compounds can be used alone or in combination.

The amino resin to be used may be a commercially available product. Examples of commercially available products preferably used include Cymels 301, 303LF, 304, 323, 325, 328, 370, 659, and 1123 available from Allnex; and Luwipals 014, 015, 018, 066, 070, 052, and B017 available from BASF SE.

As the phenol resin and the amino resin, those prepared through etherification of part or all of the methylol groups, which are formed through addition of formaldehyde, with alcohols having 1 to 12 carbon atoms are also suitably used.

When used, the curing agent (D) is added in an amount of preferably 0.5 to 20 parts by mass, more preferably 1 to 10 parts by mass relative to 100 parts by mass of the composite resin (C). The mass ratio of these within this range can further improve the retort resistance, the anticorrosion, and the processability.

The aqueous coating composition according to the present disclosure can also contain a lubricant such as wax and a curing catalyst as needed to prevent scratches of the coating film during the can manufacturing process.

Examples of the wax include animal- and plant-derived waxes such as bees wax, lanolin wax, spermaceti, candelilla wax, carnauba wax, candelilla wax, Japan wax, jojoba oil, and palm oil;

mineral and petroleum waxes such as montan wax, ozokerite, ceresin, paraffin wax, microcrystalline wax, and petrolatum;

synthetic waxes such as Fischer-Tropsch wax, polyethylene wax, oxidized polyethylene wax, oxidation polypropylene wax, montan wax derivative, paraffin wax derivative, microcrystalline wax derivative, and Teflon (registered trademark) wax.

Examples of the curing catalyst include dodecylbenzenesulfonic acid, methane sulfonic acid, p-toluene sulfonic acid, dinonylnaphthalene disulfonic acid, trifluoro methane sulfonic acid, phosphate compounds, sulfuric acid, and neutralized products thereof.

To enhance the application properties as needed, the aqueous coating composition according to the present disclosure may contain a variety of components such as a surfactant, an antifoaming agent, and a leveling agent.

To color the coating film and impart designability as needed, the aqueous coating composition according to the present disclosure can contain dyes, organic pigments, and inorganic pigments.

### Application of Aqueous Coating Composition

The aqueous coating composition according to the present disclosure can be suitably used to form a coating film which covers members made of metals and plastics. In particular, the aqueous coating composition according to the present disclosure is preferably used in applications to coatings for containers which accommodate beverages or food products, such as cans. Because the aqueous coating composition according to the present disclosure can be used irrespective of inner surfaces or outer surfaces and has high processability, use for coating the inner surfaces of cans is more preferred, and use in the inner surfaces of beverage cans is particularly preferred. Among these, preferred is use for inner surfaces of can body members or can lid members. The aqueous coating composition according to the present disclosure can also be suitably used in containers for engine oil in addition to those for food products. Needless to say, the aqueous coating composition according to the present disclosure can also be used to cover the outer surfaces of cans.

The metal is preferably aluminum, a tin-plated steel sheet, a chromium-treated steel sheet, or a nickel-treated steel sheet, for example. The metal can further be subjected to a surface treatment such as a zirconium treatment or a phosphoric acid treatment. The plastics are preferably polyolefins such as polyethylene and polypropylene, and polyesters such as polyethylene terephthalate.

Known coating methods such as spray coating (such as air spraying, airless spraying, and electrostatic spraying), roll coating, immersion coating, and electrodeposition coating can be used.

If the metal is coated, the coating is baked at a temperature of 150 to 350° C. preferably for 10 seconds to 30 minutes, more preferably 10 seconds to 15 minutes.

### Member for Can, and Can

Although cans for accommodating beverages and food products have a variety of forms, such cans are formed of a combination of at least two members for a can. Such cans are mainly classified into two: a 2-piece can (in a broad sense) composed of a bottomed cylindrical member having a can body integrally formed with a bottom and a lid member, and a 3-piece can composed of a cylindrical can body, a lid member and a bottom member disposed on the top and bottom of the can body, respectively. The 2-piece can (in a broad sense) includes a so-called bottle can which includes a recappable lid member and a bottle member. The bottle member of the bottle can includes an opening for drink, and the opening includes a screw enabling opening/closing of the lid member.

The dry thickness (coating amount) of the coating film is not particularly limited and may be appropriately selected according to the type of member. The dry thickness is usually preferably about 1 to 200 mg/dm², more preferably 5 to 180 mg/dm².

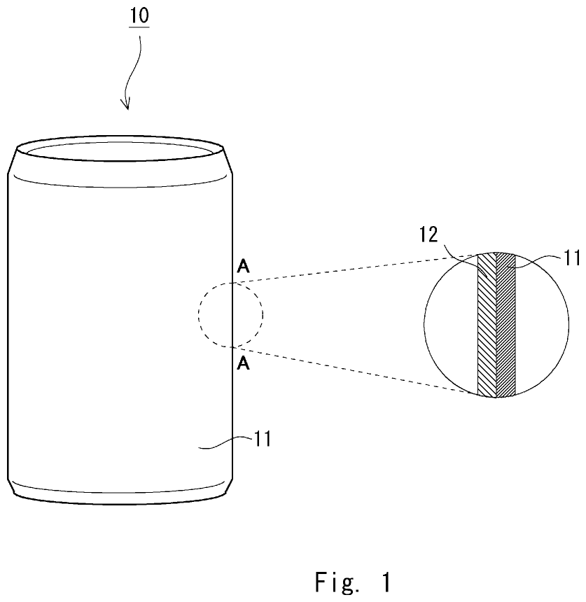

One example of the member for a can will be described with reference to FIG. 1.

FIG. 1 is a schematic view illustrating a bottomed cylindrical member for a 2-piece can according to one embodiment among the members for a can. FIG. 1 illustrates an overall view of the bottomed cylindrical member and an enlarged view of a cross-section of a portion A-A. The bottomed cylindrical member 10 illustrated in the example in FIG. 1 includes a coating film 12 of the aqueous coating composition disposed inside of the can member 11. Such a bottomed cylindrical member can be prepared as follows: A circular member in the form of a flat plate for one can is punched out of a flat plate-like can substrate having a large area, and the circular member in the form of a flat plate is molded in a bottomed cylinder. The aqueous coating composition is applied to the inner surface of the cylinder by spray coating, and is cured to form a coating film of the inner surface. The coating film for the outer surface can be appropriately formed simultaneously with, before, or after the formation of the coating film for the inner surface.

In the bottomed cylindrical member for the 2-piece can, the curing condition for the coating is baking at a temperature of 150 to 300° C. for preferably 10 seconds to 10 minutes, for more preferably 30 seconds to 5 minutes. The dry thickness (coating amount) of the coating film in the bottomed cylindrical member for a can is usually preferably about 5 to 150 mg/dm², more preferably 10 to 100 mg/dm².

Among the member for a cans, the can body member for the 3-piece can can be prepared as follows. Specifically, the aqueous coating composition is applied to the surface of a flat plate can substrate with a roll coater or the like, and is cured to form a coating film. A rectangular member for one can is cut out of the flat plate-like can substrate having the coating film. The resulting rectangular laminate is rolled into a cylinder, and ends are joined to form the body of the container. The coating film for the outer surface can be appropriately formed simultaneously to, before, or after the formation of the coating film for the inner surface.

Among the members for a can, the lid member and the bottom member are formed as follows: The aqueous coating composition is applied to the surface of a flat plate can substrate or the surface of a rolled elongate can substrate with a roll coater or the like, and is cured to form a coating film. A flat plate circular member for one can is punched out thereof.

In the lid member, a portion to be an opening is further formed by a complex and sophisticated molding process to produce a large amount of depressions and projections. For this reason, the coating film for a lid requires higher process ability than that for the coating films for other members. On the other hand, openability (sharp cut) is required such that the coating around the opening is not left on the opening side during formation of the opening.

The opening of the can body member may be joined to the lid member and the bottom member having a diameter larger than that of the opening of the can body member in some cases. As a result of joint, the joint portions on the circumferences of the lid member and the bottom member may be projected outward from the body of the can body member. Accordingly, the coating film for the outer surfaces of the lid member and the bottom member requires high slip properties and scratch resistance.

In the lid member and the bottom member, the curing condition for the coating is baking at a temperature of 150 to 350° C. for preferably 10 seconds to 30 minutes, more preferably 10 seconds to 15 minutes. The dry thickness (coating amount) of the coating film for the lid member and the bottom member is usually preferably about 10 to 200 mg/dm², more preferably 20 to 180 mg/dm². If a rolled elongate can substrate is used, the curing condition for the coating is baking at a temperature of 200 to 350° C. for preferably 10 seconds to 3 minutes, more preferably 10 seconds to 1 minute. The dry thickness (coating amount) of the coating film is usually preferably about 10 to 200 mg/dm², more preferably 20 to 180 mg/dm².

Examples of the can substrate include aluminum, tin-plated steel sheets, chromium-treated steel sheets, and nickel-treated steel sheets. These can be further subjected to a surface treatment such as zirconium treatment or phosphoric acid treatment.

The can according to the present disclosure comprises a plurality of members for a can which form the can, the plurality of members for a can at least partially including a member for a can.

In the 2-piece can, the opening end of the bottomed cylindrical member is trimmed, the content is placed thereinto, and the lid member is attached to the opening to form an openable can.

In the 3-piece can, the opening ends in both ends of the cylindrical member are trimmed, the bottom member is attached, and a content is placed thereinto. The lid member is then attached to form an openable can.

The coating film formed from the aqueous coating composition according to the present disclosure has reduced adsorption of flavor odor components of the can contents such as beverages and food products, and has high retort resistance. For this reason, the coating film is suitable as a coating for inner surfaces. The coating film also has high processability and openability, and is also suitable as a coating for an inner surface and a coating for an outer surface of the can lid. In the coating for an outer surface, it is preferred that a wax or silicone be added to enhance the slip properties and scratch resistance of the coating film.

The can according to the present disclosure is preferably applied to accommodation of beverages such as drinking water, soft drinks, tea beverages, and alcohol beverages as contents. The can according to the present disclosure may also accommodate non-beverages such as fish meat and fruits.

The can according to the present disclosure has high flavor retentiveness of alcohol beverages in particular because the coating film on the inner surface of the can hardly adsorbs flavor components, particularly ester compounds and limonene in beverages during beverages filled into the cans in a predetermined step.

Examples of ester compounds in the alcohol beverages in the present disclosure include ethyl acetate, ethyl caproate, ethyl caprylate, isoamyl acetate, and 2-phenylethyl acetate as described in “List of Brewing Components (edited by Foundation of Brewing Society of Japan)”. Although a variety of flavor substances are contained in the alcohol beverages, low adsorption of such ester compounds listed above is important because of a large content and a low functional threshold in particular.

### EXAMPLES

The present disclosure will now be more specifically described by way of Examples, but the present disclosure will not be limited to these Examples. In Examples, the term “parts” indicates parts by mass, and “%” indicates % by mass.

### Measurement Conditions for Number Average Molecular Weight and Mass Average Molecular Weight

Measurement was performed using a high performance GPC apparatus 8020 series (THF solvent, column temperature: 40° C., polystyrene standards) available from Tosoh Corporation. Specifically, four G1000 HXL, G2000 HXL, G3000 HXL, and G4000 HXL columns available from Tosoh Corporation were connected in series, and the measurement was performed at a flow rate of 1.0 ml/min to determine the number average molecular weight and the mass average molecular weight.

### Production Example 1

### Preparation of Epoxy Resin (A-1) not having Bisphenol Skeleton and the Like

1000 parts by mass of polyester (FC-2976 available from Mitsubishi Chemical Corporation, acid value: 61.4 mgKOH/g) comprising 360 parts by mass of a hydrogenated bisphenol A liquid epoxy resin (epoxy equivalent: 198 g/equivalent), terephthalic acid, isophthalic acid, ethylene glycol, and neopentyl glycol, and 0.36 parts by mass of N,N-dimethylbenzylamine were placed into a 3 L flask, and were subjected to a polymerization reaction under a nitrogen gas atmosphere at 150° C. for 6 hours to prepare Epoxy resin (A-1) having a mass average molecular weight of 18,000 and an epoxy equivalent of 2,500.

### Production Example 2

### Preparation of Epoxy Resin (A-2) not having Bisphenol Skeleton and the Like

1166 parts by mass of polyester (FC-2976 available from Mitsubishi Chemical Corporation, acid value: 61.4 mgKOH/g) comprising 230 parts by mass of 1,6-hexanediol diglycidyl ether (epoxy equivalent: 116 g/equivalent), terephthalic acid, isophthalic acid, ethylene glycol, and neopentyl glycol, and 0.23 parts by mass of N,N-dimethylbenzylamine were placed into a 3 L flask, and were subjected to a polymerization reaction under a nitrogen gas atmosphere at 150° C. for 6 hours to prepare Epoxy resin (A-2) having a mass average molecular weight of 23,000 and an epoxy equivalent of 3,200.

### Production Example 3

### Preparation of Epoxy Resin (A-3) not having Bisphenol Skeleton and the Like

185 parts by mass of polyester (FC-2976 available from Mitsubishi Chemical Corporation, acid value: 61.4 mgKOH/g) comprising 46 parts by mass of cyclohexanedimethanol diglycidyl ether (epoxy equivalent: 144 g/equivalent), terephthalic acid, isophthalic acid, ethylene glycol, and neopentyl glycol and 0.05 parts by mass of N,N-dimethylbenzylamine were placed into a 0.5 L flask, and were subjected to a polymerization reaction under a nitrogen gas atmosphere at 150° C. for 6 hours to prepare Epoxy resin (A-3) having a mass average molecular weight of 16,000 and an, epoxy equivalent of 2,400.

### Production Example 4

### Preparation of Epoxy Resin (A-4) not having Bisphenol Skeleton and the Like

781 parts by mass of polyester (FC-2976 available from Mitsubishi Chemical Corporation, acid value: 61.4 mgKOH/g) comprising 200 parts by mass of 1,4-butanediol diglycidyl ether (epoxy equivalent: 109 g/equivalent), terephthalic acid, isophthalic acid, ethylene glycol, and neopentyl glycol, and 0.2 parts by mass of N,N-dimethylbenzylamine were placed into a 2 L flask, and were subjected to a polymerization reaction under a nitrogen gas atmosphere at 150° C. for 6 hours to prepare Epoxy resin (A-4) having a mass average molecular weight of 28,000 and an epoxy equivalent of 4,000.

### Production Example 5

### Preparation of Epoxy Resin (A-5) not having Bisphenol Skeleton and the Like

1075 parts by mass of polyester (FC-2976 available from Mitsubishi Chemical Corporation, acid value: 61.4 mgKOH/g) comprising 180 parts by mass of resorcinol diglycidyl ether (epoxy equivalent: 113 g/equivalent), terephthalic acid, isophthalic acid, ethylene glycol, and neopentyl glycol, and 0.2 parts by mass of N,N-dimethylbenzylamine were placed into a 2 L flask, and were subjected to a polymerization reaction under a nitrogen gas atmosphere at 150° C. for 6 hours to prepare Epoxy resin (A-5) having a mass average molecular weight of 25,000 and an epoxy equivalent of 3,500.

### Production Example 6

### Preparation of Epoxy Resin (A-6) not having Bisphenol Skeleton and the Like

970 parts by mass of polyester (FC-2976 available from Mitsubishi Chemical Corporation, acid value: 61.4 mgKOH/g) comprising 120 parts by mass of hydroquinone diglycidyl ether (epoxy equivalent: 128 g/equivalent), terephthalic acid, isophthalic acid, ethylene glycol, and neopentyl glycol, and 0.1 parts by mass of N,N-dimethylbenzylamine were placed into a 2 L flask, and were subjected to a polymerization reaction under a nitrogen gas atmosphere at 150° C. for 6 hours to prepare Epoxy resin (A-6) having a mass average molecular weight of 32,000 and an epoxy equivalent of 4,700.

### Production Example 7

### Preparation of Epoxy Resin (A-7) not having Bisphenol Skeleton and the Like

772 parts by mass of polyester (FC-2976 available from Mitsubishi Chemical Corporation, acid value: 61.4 mgKOH/g) comprising 120 parts by mass of isosorbide diglycidyl ether (epoxy equivalent: 130 g/equivalent), terephthalic acid, isophthalic acid, ethylene glycol, and neopentyl glycol, and 0.1 parts by mass of N,N-dimethylbenzylamine were placed into a 2 L flask, and were subjected to a polymerization reaction under a nitrogen gas atmosphere at 150° C. for 6 hours to prepare Epoxy resin (A-7) having a mass average molecular weight of 21,000 and an epoxy equivalent of 3,000.

TABLE 1

| | | | Production Example | | | | | | |
|---|---|---|---|---|---|---|---|---|---|
| | | | 1 | 2 | 3 | 4 | 5 | 6 | 7 |
| Epoxy resin (A) not having bisphenol skeleton | | | A-1 | A-2 | A-3 | A-4 | A-5 | A-6 | A-7 |
| Composition | Epoxy | Hydrogenated bisphenol | 360 | | | | | | |
| (mass ratio) | compound | A liquid epoxy resin | | | | | | | |
| | | 1,6-Hexanediol | | 230 | | | | | |
| | | diglycidyl ether | | | | | | | |
| | | Cyclohexanedimethanol | | | 46 | | | | |
| | | diglycidyl ether | | | | | | | |
| | | 1,4-Butanediol | | | | 200 | | | |
| | | diglycidyl ether | | | | | | | |
| | | Resorcinol | | | | | 180 | | |
| | | diglycidyl ether | | | | | | | |
| | | Hydroquinone | | | | | | 120 | |
| | | diglycidyl ether | | | | | | | |
| | | Isosorbide | | | | | | | 120 |
| | | diglycidyl ether | | | | | | | |

| | | | | | | | |
|---|---|---|---|---|---|---|---|
| Polyester | 1000 | 1116 | 185 | 781 | 1075 | 970 | 772 |

| | | | | | | | |
|---|---|---|---|---|---|---|---|
| Mass average molecular weight | 18,000 | 23,000 | 16,000 | 28,000 | 25,000 | 32,000 | 21,000 |
| Epoxy equivalent [g/eq.] | 2,500 | 3,200 | 2,400 | 4,000 | 3,500 | 4,700 | 3,000 |

### [Production Example 101] Can Body Member

### Preparation of Solution of Acrylic Copolymer (B-1)

Monomers (methacrylic acid:styrene:ethyl acrylate=55:35:10 (mass ratio) were polymerized in a solution (butyl cellosolve:n-butanol=58:42 (mass ratio)) in the presence of benzoyl peroxide to prepare a solution of Acrylic copolymer (B-1) having a solid content of 23.5%.

### [Production Examples 102 to 105] Can Body Member

### Preparation of Solutions of Acrylic Copolymers (B-2) to (B-5)

Solutions of Acrylic copolymers (B-2) to (B-5) having a solid content of 23.5% were prepared in the same manner as in Production Example 101 except that the compositional ratio of the monomers and the amount of benzoyl peroxide were varied as shown in Table 2.

### [Production Example 106] Can Lid Member

### Preparation of Solution of Acrylic Copolymer (B-6)

Monomers (methacrylic acid:styrene:ethyl acrylate=50:25:25 (mass ratio)) were polymerized in a solution (diethylene glycol monobutyl ether:butyl cellosolve=73:27 (mass ratio)) in the presence of benzoyl peroxide to prepare a solution of Acrylic copolymer (B-6) having a solid content of 23.5%.

### [Production Examples 107 and 108] Can Lid Member

### Preparation of Solutions of Acrylic Copolymers (B-7) and (B-8)

Solutions of Acrylic copolymers (B-7) and (B-8) having a solid content of 23.5% were prepared in the same manner as in Production Example 106 except that the compositional ratio of the monomers and the amount of benzoyl peroxide were varied as shown in Table 2.

TABLE 2

| | | | Production Example | | | | | | | |
|---|---|---|---|---|---|---|---|---|---|---|
| | | | Can body member | | | | | Can lid member | | |
| | | | 101 | 102 | 103 | 104 | 105 | 106 | 107 | 108 |
| Acrylic copolymer (B) | | | (B)-1 | (B)-2 | (B)-3 | (B)-4 | (B)-5 | (B)-6 | (B)-7 | (B)-8 |
| Monomer | Carboxyl | MAA | 55 | 50 | 60 | 65 | 40 | 50 | 45 | 60 |
| composition | group-containing | | | | | | | | | |
| (mass ratio) | monomer | | | | | | | | | |
| | Ethylenically | St | 35 | 25 | | | 40 | 25 | | 10 |
| | unsaturated | EA | 10 | 15 | | | 20 | 25 | 10 | 15 |
| | monomer | MMA | | 10 | 15 | 5 | | | 15 | |
| | | EMA | | | 10 | | | | | |
| | | BMA | | | 15 | 30 | | | 30 | 15 |

| | | | | | | | | |
|---|---|---|---|---|---|---|---|---|
| Number average molecular weight | 15,000 | 16,000 | 14,000 | 9,000 | 21,000 | 13,000 | 19,000 | 9,000 |

The abbreviations in Table 2 represent:

MAA: methacrylic acid

St: styrene

EA: ethyl acrylate

MMA: methyl methacrylate

EMA: ethyl methacrylate

BMA: butyl methacrylate

### Coating for Inner Surface of Can Body of 2-Piece Can

### Example 1

### Preparation of Aqueous Coating Composition (Esterification)

128 parts of Epoxy resin (A-1) and 136.2 parts (containing about 32 parts of non-volatile contents) of the solution of Acrylic copolymer (B-1) were placed into a reaction container including a stirrer, a thermometer, a reflux cooling tube, a dropping tank, and a nitrogen gas introduction pipe, and were heated to 120° C., followed by stirring to completely dissolve the epoxy resin. Subsequently, the system was cooled to 90° C. While the system was kept at 90° C., 7.3 parts of dimethylaminoethanol was added to perform a reaction for 3 hours to prepare a composite resin. The amount of dimethylaminoethanol is 40 mol % relative to the amount of methacrylic acid which forms Acrylic copolymer (B-1). Subsequently, 527.8 parts of deionized water was gradually added dropwise over 1 hour to prepare an aqueous coating composition having a solid content of 20.0%.

The mass ratio of Epoxy resin (A-1) and Acrylic copolymer (B-1) fed in the reaction is 80:20.

### Preparation of Test Panel 1

For evaluation of performance of the coating film, the aqueous coating composition prepared in Example 1 was applied onto an aluminum plate having a thickness of 0.1 mm with a bar coater such that the dry coating mass after baking was 45 mg/dm², and was baked and dried at 200° C. for 120 seconds to prepare a test panel.

### Bending Processability

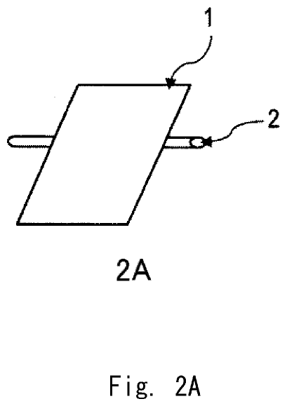

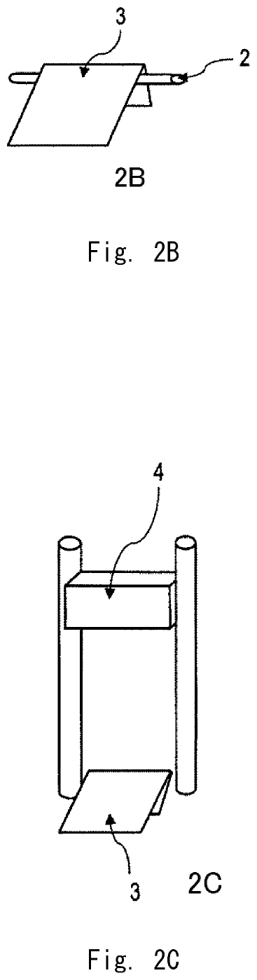

The bending processability of Test panel 1 at the initial stage and after anticorrosion tests 1 and 2 were evaluated by the following procedure according to the following criteria. These evaluations will be described with reference to FIGS. 2A to 2C.

Test panel 1 having a width of 30 mm and a length of 50 mm was prepared (Test piece 1).

Next, as shown in FIG. 2A, Test piece 1 was disposed with its coating film facing outward, and was supported at a position corresponding to a length of 30 mm of the test piece by a rod 2 having a diameter of 3 mm. As shown in FIG. 2B, Test piece 1 was bent into two along the rod 2 to prepare Test piece 3 having a width of 30 mm and a length of about 30 mm. Three aluminum plates (not shown) having a thickness of 0.26 mm were sandwiched between the two-bent Test piece 3. As shown in FIG. 2C, a 1 kg cuboidal weight 4 having a width of 15 cm, a height of 5 cm, and a length of 5 cm was dropped from a height of 40 cm onto the bent portion of Test piece 3 to completely bend the bent portion. Thus, Test piece 5 was prepared.

Next, the bent portion of Test piece 5 was immersed in 1% saline water. Next, the metal portion in the flat portion of Test piece 5 not immersed in saline water and saline water were electrically conducted at 6.0 V for 4 seconds to measure the current value. The bending and the electrical conduction test both were performed around 23° C.

If the coating film has poor processability, the coating film in the bent portion cracks and the underlying metal plate is exposed to increase the conductivity. Accordingly, the current value increases.

### Criteria for Evaluation [Initial Stage]

A: less than 5 mA

B: 5 mA or more and less than 10 mA

C: 10 mA or more and less than 20 mA

D: 20 mA or more

A result of evaluation “B” indicates that the coating film has favorable bending processability in the initial stage, and “A” indicates that the coating film has excellent bending processability in the initial stage. In contrast, “D” indicates poor bending processability.

### Anticorrosion Test 1

Test panel 1 was immersed for 60 minutes in a 10% ethanol aqueous solution heated to 100° C., and was spontaneously cooled to 50° C. Test panel 1 was stored at 50° C. for one month, and was spontaneously cooled to around 23° C.

### Anticorrosion Test 2

A 10% ethanol aqueous solution containing citric acid having a pH of about 3 was heated to 100° C., and Test panel 1 was immersed therein for 60 minutes. Test panel 1 was spontaneously cooled to 50° C., was stored at 50° C. for one month, and was spontaneously cooled to around 23° C.

### Criteria for Evaluation [After Anticorrosion Tests 1 and 2]

A: less than 10 mA

B: 10 mA or more and less than 15 mA

C: 15 mA or more and less than 20 mA

D: 20 mA or more

A result of evaluation “B” indicates that the test panel has favorable anticorrosion, and “A” indicates that the test panel has excellent anticorrosion. In contrast, “D” indicates poor anticorrosion.

### Retort Resistance Test

While Test panel 1 was immersed in water, Test panel 1 was subjected to a retort treatment in a retort tank at 125° C. for 30 minutes, and the appearance of the coating film was visually evaluated.

A: The coating film is not different from an untreated coating film.

B: The coating film is very slightly whitened.

C: The coating film is slightly whitened.

D: The coating film is remarkably whitened.

A result of evaluation “B” indicates that the coating film has favorable retort resistance, and “A” indicates that the coating film has excellent retort resistance. In contrast, “D” indicates poor retort resistance.

### Adsorption of Flavor Components

The flavor standard substances were used: ethyl acetate, ethyl caproate, ethyl caprylate, isoamyl acetate, and 2-phenylethyl acetate, which are important ester compounds because of a large content and a low functional threshold, as well as limonene as a representative component of the orange flavor. Each Test panel 1 having a coating film area of 500 cm² was immersed in 500 cc of a 5% ethanol aqueous solution containing 5 ppm of each of flavor standard substances (6 substances of ethyl acetate, ethyl caproate, ethyl caprylate, isoamyl acetate, 2-phenylethyl acetate, and limonene), and the container was tightly sealed. The container was left to stand at 30° C. for three months. After three months passed, the test panel was taken out, and was washed with distilled water. The coating film was reimmersed in 10 cc of carbon disulfide to extract the flavor standard substances adsorbed by the test panel. The amounts of the adsorbed flavor standard substances were determined by gas chromatography. The adsorption rates of the flavor components were calculated from the amounts thereof adsorbed by the coating film, where the amount of each flavor standard substance contained in the immersion solution (500 cc) was 100%, and evaluation was performed according to the following criteria. A lower adsorption rate indicates higher flavor retentiveness.

A: The average of the adsorption rates of the 6 flavor substances is less than 5.0%.

B: The average of the adsorption rates of the 6 flavor substances is 5.0% or more and less than 10%.

C: The average of the adsorption rates of the 6 flavor substances is 10% or more and less than 20%.

D: The average of the adsorption rates of the 6 flavor substances is 20% or more.

A result of evaluation “B” indicates that the coating film has favorable flavor retentiveness, and “A” indicates that the coating film has excellent flavor retentiveness. In contrast, “D” indicates poor flavor retentiveness.

### Adhesion (Cross-Cut Peeling Test)

The coating film of Test panel 1 was cut with a cutter such that 11 scratches orthogonal to each other at an interval of 1 mm reached the substrate. While the resulting test panels were immersed in water or an aqueous solution containing citric acid having a pH of about 2, the test panels were subjected to a retort treatment in a retort tank at 125° C. for 30 minutes, and were spontaneously cooled to around 23° C. The resulting products were used as test pieces for evaluation of adhesion.

A cellophane tape was tightly applied to the scratches of the test pieces, and was peeled to observe the peel state of the coating film.

A: no peel

B: less than 5% of peel is observed

C: 5 to 20% of peel is observed

D: more than 20% of peel is observed

A result of evaluation “B” indicates that the coating film has favorable adhesion, and “A” indicates that the coating film has excellent adhesion. In contrast, “D” indicates poor adhesion.

### Amount of Extracted BPA

Test panel 1 having a coating film area of 1000 cm² was prepared. The test panel was cut into a strip having a width of 20 mm and a length of 50 mm. While the test piece was immersed in 1000 mL of water in a pressure-resistant bottle, the test piece was subjected to a retort treatment in a retort tank at 125° C. for 30 minutes. The water after the retort treatment was removed using an evaporator, and residues were dissolved with 2 mL of THF to perform analysis with HPLCs (Chromaster 5110, 5210, 5310, 5410, and 5440) available from Hitachi, Ltd.

### Examples 2 to 7

Aqueous coating compositions containing a composite resin were prepared in the same manner as in Example 1 by reacting the epoxy resin (A) with the acrylic copolymer (B) at 80:20 (mass ratio) except that Epoxy resins (A-2) to (A-7) were used instead of Epoxy resin (A-1).

### Examples 8 to 10

aqueous coating compositions were prepared in the same manner as in Example 1 except that the mass ratio during the reaction of Epoxy resin (A-1) with Acrylic copolymer (B-1) was changed to 85:15, 75:25, and 65:35, respectively. The amount of dimethylaminoethanol was 40 mol % relative to methacrylic acid that formed Acrylic copolymer (B-1).

### Examples 11 to 14, Examples 15 to 18

Aqueous coating compositions were prepared in the same manner as in Example 1 by reacting the epoxy resin (A) with the acrylic copolymer (B) at 80:20 (mass ratio) except that Epoxy resin (A-2) was used in Examples 11 to 14 and Epoxy resin (A-5) was used in Example 15 to 18 instead of Epoxy resin (A-1), and solutions of Acrylic copolymers (B-2) to (B-5) were used instead of the solution of Acrylic copolymer (B-1).

### Examples 19 and 20

Aqueous coating compositions were prepared in the same manner as in Examples 8 and 10 by reacting Epoxy resin (A-2) with Acrylic copolymer (B-1) at mass ratios of 85:15 and 65:35, respectively, except that that Epoxy resin (A-2) was used instead of Epoxy resin (A-1).

### Examples 21 and 22

Aqueous coating compositions were prepared in the same manner as in Examples 8 and 10 by reacting Epoxy resin (A-2) with Acrylic copolymer (B-3) at mass ratios of 85:15 and 65:35, respectively, except that Epoxy resin (A-2) was used instead of Epoxy resin (A-1) and Acrylic copolymer (B-3) was used instead of Acrylic copolymer (B-1).

### Examples 23 to 26

Aqueous coating compositions were prepared in the same manner as in Example 19 to 22 by reacting Epoxy resin (A-5) with Acrylic copolymer (B-1) or (B-3) at mass ratios of 85:15 and 65:35, respectively, except that Epoxy resin (A-5) was used instead of Epoxy resin (A-2).

### Example 27

### Preparation of Aqueous Coating Composition (Grafting)

128 parts of Epoxy resin (A-1), 60.0 parts of butyl cellosolve, and 43.2 parts of n-butanol were placed into a reaction container including a stirrer, a thermometer, a reflux cooling tube, a dropping tank, and a nitrogen gas introduction pipe, and were heated to 120° C., followed by stirring to completely dissolve the epoxy resin. While the inside of the reaction container was kept at 120° C., a solution of an acrylic monomer and a polymerization initiator prepared by mixing 17.6 parts of methacrylic acid, 11.2 parts of styrene, 3.2 parts of ethyl acrylate, and 1.5 parts of benzoyl peroxide was added dropwise over 1 hour. After the addition was completed, the solution was further kept at 120° C. for 1 hour, and was cooled to 90° C. to yield a composite resin. As a neutralizer, 7.3 parts of dimethylaminoethanol was added. Subsequently, 527.3 parts of deionized water was gradually added dropwise over 1 hour to prepare an aqueous coating composition having a solid content of 20.0%.

The mass ratio of Epoxy resin (A-1) to the acrylic monomer and the like fed to the reaction is 80:20.

### Example 28

### Preparation of Aqueous Coating Composition (Direct Method)

128 parts of Epoxy resin (A-1), 60.0 parts of butyl cellosolve, and 43.2 parts of n-butanol were placed into a reaction container including a stirrer, a thermometer, a reflux cooling tube, a dropping tank, and a nitrogen gas introduction pipe, and were heated to 120° C., followed by stirring to completely dissolve the epoxy resin. While the inside of the reaction container was kept at 120° C., 0.8 parts of methacrylic acid and 0.004 parts of hydroquinone were placed thereinto. Next, 0.15 parts of a 25% sodium hydroxide aqueous solution was placed thereinto to perform a reaction for 3 hours.

After the system was cooled to 90° C., the temperature was kept, a solution of an acrylic monomer and a polymerization initiator prepared by mixing 16.8 parts of methacrylic acid, 11.2 parts of styrene, 3.2 parts of ethyl acrylate, and 1 part of benzoyl peroxide was added dropwise over 1 hour. The system was further kept at 90° C. for 1 hour to yield a composite resin, and was cooled to 60° C. As a neutralizer, 7.3 parts of dimethylaminoethanol was added. Subsequently, 527.7 parts of deionized water was gradually added dropwise over 1 hour to prepare an aqueous coating composition having a solid content of 20.0%.

The mass ratio of Epoxy resin (A-1) to the acrylic monomers and the like fed to the reaction is 80:20.

### Example 29

### Preparation of Aqueous Coating Composition (Grafting)

112 parts of Epoxy resin (A-2), 90.1 parts of butyl cellosolve, and 65.1 parts of n-butanol were placed into a reaction container including a stirrer, a thermometer, a reflux cooling tube, a dropping tank, and a nitrogen gas introduction pipe, and were heated to 120° C., followed by stirring to completely dissolve the epoxy resin. While the inside of the reaction container was kept at 120° C., a solution of an acrylic monomer and a polymerization initiator prepared by mixing 26.4 parts of methacrylic acid, 16.8 parts of styrene, 4.8 parts of ethyl acrylate, and 2.2 parts of benzoyl peroxide was added dropwise over 1 hour. After the addition was completed, the system was further kept at 120° C. for 1 hour, and was cooled to 90° C. to yield a composite resin. As a neutralizer, 11 parts of dimethylaminoethanol was added. Subsequently, 470.6 parts of deionized water was gradually added dropwise over 1 hour to prepare an aqueous coating composition having a solid content of 20.0%.

The mass ratio of Epoxy resin (A-2) to the acrylic monomer and the like fed to the reaction is 70:30.

### Example 30

### Preparation of Aqueous Coating Composition (Direct Method)

112 parts of Epoxy resin (A-2), 90.1 parts of butyl cellosolve, and 65.1 parts of n-butanol were placed into a reaction container including a stirrer, a thermometer, a reflux cooling tube, a dropping tank, and a nitrogen gas introduction pipe, and were heated to 120° C., followed by stirring to completely dissolve the epoxy resin. While the inside of the reaction container was kept at 120° C., 0.7 parts of methacrylic acid and 0.004 parts of hydroquinone were placed thereinto, and 0.13 parts of a 25% sodium hydroxide aqueous solution was placed thereinto to perform a reaction for 3 hours.

The system was cooled to 90° C., and the temperature was kept. A solution of an acrylic monomer and a polymerization initiator prepared by mixing 25.7 parts of methacrylic acid, 16.8 parts of styrene, 4.8 parts of ethyl acrylate, and 1.5 parts of benzoyl peroxide was added dropwise over 1 hour. The system was further kept at 90° C. for 1 hour to yield a composite resin, and was cooled to 60° C. As a neutralizer, 11 parts of dimethylaminoethanol was added. Subsequently, 471.2 parts of deionized water was gradually added dropwise over 1 hour to prepare an aqueous coating composition having a solid content of 20.0%.

The mass ratio of Epoxy resin (A-2) to the acrylic monomer and the like fed to the reaction is 70:30.

### Example 31 (Grafting), Example 32 (Direct Method)

### Preparation of Aqueous Coating Composition

Aqueous coating compositions having a solid content of 20.0% were prepared by grafting in the same manner as in Example 27 and by the direct method in the same manner as in Example 28 except that Epoxy resin (A-5) was used instead of Epoxy resin (A-1).

### Example 33

### Preparation of Aqueous Coating Composition (Grafting)

120 parts of Epoxy resin (A-7), 75.1 parts of butyl cellosolve, and 54.2 parts of n-butanol were placed into a reaction container including a stirrer, a thermometer, a reflux cooling tube, a dropping tank, and a nitrogen gas introduction pipe, and were heated to 120° C., followed by stirring to completely dissolve the epoxy resin. While the inside of the reaction container was kept at 120° C., a solution of an acrylic monomer and a polymerization initiator prepared by mixing 24.0 parts of methacrylic acid, 6.0 parts of methyl methacrylate, and 4.0 parts of ethyl methacrylate, 6.0 parts of butyl methacrylate, and 1.8 parts of benzoyl peroxide was added dropwise over 1 hour. After the addition was completed, the system was further kept at 120° C. for 1 hour, and was cooled to 90° C. to yield a composite resin. As a neutralizer, 10 parts of dimethylaminoethanol was added. Subsequently, 498.9 parts of deionized water was gradually added dropwise over 1 hour to prepare an aqueous coating composition having a solid content of 20.0%.

The mass ratio of Epoxy resin (A-7) to the acrylic monomer and the like fed to the reaction is 75:25.

### Example 34

### Preparation of Aqueous Coating Composition (Direct Method)

120 parts of Epoxy resin (A-7), 75.1 parts of butyl cellosolve, and 54.2 parts of n-butanol were placed into a reaction container including a stirrer, a thermometer, a reflux cooling tube, a dropping tank, and a nitrogen gas introduction pipe, and were heated to 120° C., followed by stirring to completely dissolve the epoxy resin. While the inside of the reaction container was kept at 120° C., 0.6 parts of methacrylic acid and 0.004 parts of hydroquinone were placed thereinto, and 0.14 parts of a 25% sodium hydroxide aqueous solution was placed thereinto to perform a reaction for 3 hours.

The system was cooled to 90° C., and was kept at the temperature, and a solution of an acrylic monomer and a polymerization initiator prepared by mixing 23.4 parts of methacrylic acid, 6.0 parts of methyl methacrylate, 4.0 parts of ethyl methacrylate, 6.0 parts of butyl methacrylate, and 1.3 parts of benzoyl peroxide was added dropwise over 1 hour. The system was further kept at 90° C. for 1 hour to yield a composite resin, and was cooled to 60° C. As a neutralizer, 10 parts of dimethylaminoethanol was added. Subsequently, 499.3 parts of deionized water was gradually added dropwise over 1 hour to prepare an aqueous coating composition having a solid content of 20.0%.

The mass ratio of Epoxy resin (A-7) to the acrylic monomer and the like fed to the reaction is 75:25.

### Example 16-2 to Example 16-4

As shown in Table 7, Phenodur PR612 (Allnex, phenol resin solution, solid content: 80%) was added in amounts of 1 part, 3 parts, and 8 parts by mass in terms of solid contents relative to 100 parts by mass of the composite resin contained in the aqueous coating composition in Example 16.

### Example 16-5 to Example 16-7

As shown in Table 7, Cymel 303LF (Allnex, amino resin), Primid QM-1260 (EMS Chemie Holding AG, β-hydroxyalkylamide), and Cymel NF2000 (Allnex, a tris(alkoxycarbonylamino)triazine solution, solid content: 50%) each were added in an amount of 3 parts by mass in terms of solid contents relative to 100 parts by mass of the composite resin contained in the aqueous coating composition in Example 16.

### Comparative Example 1

### Preparation of Aqueous Coating Composition (Esterification)

An aqueous coating composition having a solid content of 20.0% was prepared in the same manner as in Example 1 except that the type of raw materials and the composition in Example 1 were varied as shown in Table 6.

In Production Comparative Example 1 and Comparative Examples 2 to 4 below, preparation was performed according to the method described in “Japanese Unexamined Patent Application Publication No. 2015-193834”.

### Production Comparative Example 1

### Synthesis of Acrylic Copolymer (E)

8 parts of ethylene glycol monobutyl ether and 18.2 parts of deionized water were placed into a reaction container including a stirrer, a thermometer, a reflux cooling tube, a dropping tank, and a nitrogen gas introduction pipe, and heating was started. These were refluxed at about 100° C. Under refluxing, a mixture of 10 parts of methacrylic acid, 6 parts of styrene, 4 parts of ethyl acrylate, and 0.3 parts of benzoyl peroxide were continuously added dropwise from a dropping tank over 4 hours to perform polymerization.

After 1 hour and 2 hours from the completion of the addition, 0.03 parts of benzoyl peroxide was added, and the reaction was continued for 3 hours after the completion of the addition. Subsequently, the system was cooled to prepare a solution (non-volatile contents: 41%) of an acrylic copolymer having a number average molecular weight of 25000 and a glass transition temperature of 80° C.

Next, 5.2 parts of dimethylethanolamine was added, followed by stirring for 10 minutes. 46.3 parts of deionized water was added to dissolve the acrylic copolymer in water. As a result, an aqueous solution of Acrylic copolymer (E) having non-volatile contents of 20% and having a carboxyl group without a cross-linkable functional group other than the carboxyl group was prepared.

### Comparative Example 2

### Preparation of Aqueous Coating Composition

45 parts of the aqueous solution of Acrylic copolymer (E) prepared in Production Comparative Example 1 and 18.5 parts of deionized water were placed into a reaction container including a stirrer, a thermometer, a reflux cooling tube, a dropping tank, and a nitrogen gas introduction pipe, and were heated to 70° C. under a nitrogen gas atmosphere with stirring. Separately, 5.69 parts of styrene, 15.09 parts of ethyl acrylate, and 0.22 parts of N-butoxymethylacrylamide were placed into a dropping tank 1. 0.74 parts of a 1% hydrogen peroxide solution was placed into a dropping tank 2, and 0.92 parts of a 1% sodium erythorbate aqueous solution was placed into a dropping tank 3. While the inner temperature of the reaction container was kept at 70° C. under stirring, the solutions were added dropwise from the respective dropping tanks over 3 hours to perform emulsion polymerization. A polymer emulsion was thereby prepared.

Subsequently, 57 parts of deionized water, 13.6 parts of n-butanol, 9.1 parts of ethylene glycol monobutyl ether, 0.16 parts of dodecylbenzenesulfonate, and 1.5 parts of Phenodur PR612 (Allnex, phenol resin solution, solid content: 80%) were added, followed by filtration to prepare an aqueous coating composition having non-volatile contents of 18.5%.

### Comparative Example 3

### Preparation of Aqueous Coating Composition

45 parts of the aqueous solution of Acrylic copolymer (E) prepared by Production Comparative Example 1 and 18.5 parts of deionized water were placed into a reaction container including a stirrer, a thermometer, a reflux cooling tube, a dropping tank, and a nitrogen gas introduction pipe, and were heated to 70° C. under a nitrogen gas atmosphere with stirring. Separately, 10.92 parts of styrene, 9.03 parts of ethyl acrylate, and 1.05 parts of N-butoxymethylacrylamide were placed into the dropping tank 1. 0.74 parts of a 1% hydrogen peroxide solution was placed into the dropping tank 2, and 0.92 parts of a 1% sodium erythorbate aqueous solution was placed into the dropping tank 3. While the inner temperature of the reaction container was kept at 70° C. under stirring, the solutions were added dropwise from the respective dropping tanks over 3 hours to perform emulsion polymerization. A polymer emulsion was thereby prepared.

Subsequently, 55 parts of deionized water, 13.6 parts of n-butanol, 8.6 parts of ethylene glycol monobutyl ether, 0.15 parts of dodecylbenzenesulfonate, and 1.5 parts of Phenodur PR612 (Allnex, phenol resin solution, solid content: 80%) were added, followed by filtration to prepare an aqueous coating composition having non-volatile contents of 18.5%.

### Comparative Example 4

### Preparation of Aqueous Coating Composition

45 parts of the aqueous solution of Acrylic copolymer (E) prepared by Production Comparative Example 1 and 18.5 parts of deionized water were placed into a reaction container including a stirrer, a thermometer, a reflux cooling tube, a dropping tank, and a nitrogen gas introduction pipe, and were heated to 70° C. under a nitrogen gas atmosphere with stirring. Separately, 5.69 parts of methyl methacrylate, 15.09 parts of ethyl acrylate, and 0.22 parts of N-butoxymethylacrylamide were placed into the dropping tank 1. 0.74 parts of a 1% hydrogen peroxide solution was placed into the dropping tank 2, and 0.92 parts of a 1% sodium erythorbate aqueous solution was placed into the dropping tank 3. While the inner temperature of the reaction container was kept at 70° C. under stirring, the solutions were added dropwise from the respective dropping tanks over 3 hours to perform emulsion polymerization. A polymer emulsion was thereby prepared.

Subsequently, 57 parts of deionized water, 13.6 parts of n-butanol, 9.1 parts of ethylene glycol monobutyl ether, 0.16 parts of dodecylbenzenesulfonate, and 1.5 parts of Phenodur PR612 (Allnex, phenol resin solution, solid content: 80%) were added, followed by filtration to prepare an aqueous coating composition having non-volatile contents of 18.5%.

TABLE 3

| | | | | Example | | | | | | | | | |
|---|---|---|---|---|---|---|---|---|---|---|---|---|---|
| | | | | 1 | 2 | 3 | 4 | 5 | 6 | 7 | 8 | 9 | 10 |
| Composite | Epoxy resin (A) | | Type of resin | (A)-1 | (A)-2 | (A)-3 | (A)-4 | (A)-5 | (A)-6 | (A)-7 | (A)-1 | | |
| resin | | | Mass ratio | 80 | | | | | | | 85 | 75 | 65 |
| (C) | Acrylic copolymer (B) | | Type of resin | (B)-1 | | | | | | | (B)-1 | | |
| | | | Mass ratio | 20 | | | | | | | 15 | 25 | 35 |
| | Method | | | E method | | | | | | | E method | | |
| | E method: esterification | | | | | | | | | | | | |
| | G method: grafting | | | | | | | | | | | | |
| | D method: direct method | | | | | | | | | | | | |
| Test | Bending | Initial | | A | A | B | A | A | A | A | A | A | B |
| panel | processability | Anticorrosion | After immersion in | A | A | A | A | A | A | A | A | A | A |
| 1 | | test | alcohol | | | | | | | | | | |
| | | | After immersion in | B | B | B | B | A | A | A | B | B | B |
| | | | alcohol containing | | | | | | | | | | |
| | | | citric acid (pH: 3) | | | | | | | | | | |

| | | | | | | | | | | |
|---|---|---|---|---|---|---|---|---|---|---|
| Retort resistance (presence/ | A | A | A | A | A | A | A | A | A | A |
| absence of whitening) | | | | | | | | | | |
| Adsorption of flavor components | A | B | A | B | A | A | A | A | A | A |
| Amount of extracted BPA [ppb] | ND. | N.D. | N.D. | N.D. | N.D. | N.D. | N.D. | N.D. | N.D. | N.D. |

TABLE 4

| | | | | Example | | | | | | | |
|---|---|---|---|---|---|---|---|---|---|---|---|
| | | | | 11 | 12 | 13 | 14 | 15 | 16 | 17 | 18 |
| Composite | Epoxy resin (A) | | Type of resin | (A)-2 | | | | (A)-5 | | | |
| resin | | | Mass ratio | 80 | | | | 80 | | | |
| (C) | Acrylic copolymer (B) | | Type of resin | (B)-2 | (B)-3 | (B)-4 | (B)-5 | (B)-2 | (B)-3 | (B)-4 | (B)-5 |
| | | | Mass ratio | 20 | | | | 20 | | | |
| | Method | | | E method | | | | E method | | | |
| | E method: esterification | | | | | | | | | | |
| | G method: grafting | | | | | | | | | | |
| | D method: direct method | | | | | | | | | | |
| Test | Bending | Initial | | A | A | A | A | A | A | A | A |
| panel | processability | Anticorrosion | After immersion in | A | A | A | A | A | A | A | A |
| 1 | | test | alcohol | | | | | | | | |
| | | | After immersion in | B | B | B | B | A | A | A | A |
| | | | alcohol containing | | | | | | | | |
| | | | citric acid (pH: 3) | | | | | | | | |

| | | | | | | | | |
|---|---|---|---|---|---|---|---|---|
| Retort resistance (presence/ | A | A | A | A | A | A | A | A |
| absence of whitening) | | | | | | | | |
| Adsorption of flavor components | B | B | B | B | A | A | A | A |
| Amount of extracted BPA [ppb] | N.D. | ND. | N.D. | N.D. | N.D. | N.D. | N.D. | N.D. |

TABLE 5

| | | | | Example | | | | | | | |
|---|---|---|---|---|---|---|---|---|---|---|---|
| | | | | 19 | 20 | 21 | 22 | 23 | 24 | 25 | 26 |
| Composite | Epoxy resin (A) | | Type of resin | (A)-2 | | | | (A)-5 | | | |
| resin | | | Mass ratio | 85 | 65 | 85 | 65 | 85 | 65 | 85 | 65 |
| (C) | Acrylic copolymer (B) | | Type of resin | (B)-1 | | (B)-3 | | (B)-1 | | (B)-3 | |
| | | | Mass ratio | 15 | 35 | 15 | 35 | 15 | 35 | 15 | 35 |
| | Method | | | E method | | | | E method | | | |
| | E method: esterification | | | | | | | | | | |
| | G method: grafting | | | | | | | | | | |
| | D method: direct method | | | | | | | | | | |
| Test | Bending | Initial | | A | B | A | B | A | B | A | B |
| panel | processability | Anticorrosion | After immersion in | A | A | A | A | A | A | A | A |
| 1 | | test | alcohol | | | | | | | | |
| | | | After immersion in | B | B | B | B | A | A | A | A |
| | | | alcohol containing | | | | | | | | |
| | | | citric acid (pH: 3) | | | | | | | | |

| | | | | | | | | |
|---|---|---|---|---|---|---|---|---|
| Retort resistance (presence/ | A | A | A | A | A | A | A | A |
| absence of whitening) | | | | | | | | |
| Adsorption of flavor components | B | A | B | A | A | A | A | A |
| Amount of extracted BPA [ppb] | N.D. | ND. | N.D. | N.D. | N.D. | N.D. | N.D. | N.D. |

TABLE 6

| | | | | Example | | | | |
|---|---|---|---|---|---|---|---|---|
| | | | | 27 | 28 | 29 | 30 | 31 |
| Composite | Epoxy resin (A) | | Type of resin | (A)-1 | (A)-1 | (A)-2 | (A)-2 | (A)-5 |
| resin | | | Mass ratio | 80 | 80 | 70 | 70 | 80 |
| (C) | Acrylic copolymer (B) | | Type of resin | *2 | *2 | *2 | *2 | *2 |
| | | | Mass ratio | 20 | 20 | 30 | 30 | 20 |
| | Method | | | G | D | G | D | G |
| | E method: esterification | | | method | method | method | method | method |
| | G method: grafting | | | | | | | |
| | D method: direct method | | | | | | | |
| Test | Bending | Initial | | A | A | A | A | A |
| panel | processability | Anticorrosion | After immersion in | A | A | A | A | A |
| 1 | | test | alcohol | | | | | |
| | | | After immersion in | B | B | B | B | A |
| | | | alcohol containing | | | | | |
| | | | citric acid (pH: 3) | | | | | |

| | | | | | |
|---|---|---|---|---|---|
| Retort resistance (presence/ | A | A | A | A | A |
| absence of whitening) | | | | | |
| Adsorption of flavor components | A | A | A | A | A |
| Amount of extracted BPA [ppb] | N.D. | N.D. | N.D. | N.D. | N.D. |

| | | | | | | | Comparative |
|---|---|---|---|---|---|---|---|
| | | | | Example | | | Example |
| | | | | 32 | 33 | 34 | 1 |
| Composite | Epoxy resin (A) | | Type of resin | (A)-5 | (A)-7 | (A)-7 | *1 |
| resin | | | Mass ratio | 80 | 75 | 75 | 80 |
| (C) | Acrylic copolymer (B) | | Type of resin | *2 | *3 | *3 | (B)-1 |
| | | | Mass ratio | 20 | 25 | 25 | 20 |
| | Method | | | D | G | D | E |
| | E method: esterification | | | method | method | method | method |
| | G method: grafting | | | | | | |
| | D method: direct method | | | | | | |
| Test | Bending | Initial | | A | A | A | A |
| panel | processability | Anticorrosion | After immersion in | A | A | A | A |
| 1 | | test | alcohol | | | | |
| | | | After immersion in | A | A | A | A |
| | | | alcohol containing | | | | |
| | | | citric acid (pH: 3) | | | | |

| | | | | |
|---|---|---|---|---|
| Retort resistance (presence/ | A | A | A | A |
| absence of whitening) | | | | |
| Adsorption of flavor components | A | A | A | A |
| Amount of extracted BPA [ppb] | N.D. | ND. | N.D. | 0.8 |

TABLE 7

| | | | | Example | | | | | | |
|---|---|---|---|---|---|---|---|---|---|---|
| | | | | 16 | 16-2 | 16-3 | 16-4 | 16-5 | 16-6 | 16-7 |
| Composite | Epoxy resin (A) | | Type of resin | (A)-5 | | | | | | |
| resin | | | Mass ratio | 80 | | | | | | |
| (C) | Acrylic copolymer (B) | | Type of resin | (B)-3 | | | | | | |
| | | | Mass ratio | 20 | | | | | | |
| | Method | | | E method | | | | | | |
| | E method: esterification | | | | | | | | | |
| | G method: grafting | | | | | | | | | |
| | D method: direct method | | | | | | | | | |
| Curing | Phenodur PR612 *4 | | Mass ratio | | 1 | 3 | 8 | | | |
| agent | Cymel 303LF *5 | | Mass ratio | | | | | 3 | | |
| (D) | Primid QM-1260 *6 | | Mass ratio | | | | | | 3 | |
| | Cymel NF 2000 *7 | | Mass ratio | | | | | | | 3 |
| Test | Bending | Initial | | A | A | A | B | A | A | A |
| panel | processability | Anticorrosion | After immersion in | A | A | A | A | A | A | A |
| 1 | | test | alcohol | | | | | | | |
| | | | After immersion in | A | A | A | A | A | A | A |
| | | | alcohol containing | | | | | | | |
| | | | citric acid (pH: 3) | | | | | | | |

| Retort resistance (presence/ | | A | A | A | A | A | A | A |
|---|---|---|---|---|---|---|---|---|
| absence of whitening) | | | | | | | | |
| Adsorption of flavor components | | A | A | A | A | A | A | A |
| Adhesion | Water | A | A | A | A | A | A | A |
| after | Citric acid-containing | B | A | A | A | A | A | A |
| retorting | water (pH: 2) | | | | | | | |

| | | | | | | | |
|---|---|---|---|---|---|---|---|
| Amount of extracted BPA [ppb] | N.D. | N.D. | N.D. | N.D. | N.D. | N.D. | N.D. |

TABLE 8

| | | | | Comparative Example | | |
|---|---|---|---|---|---|---|
| | | | | 2 | 3 | 4 |
| Test | Bending | Initial | | B | C | C |
| panel | processability | Anticorrosion | After immersion in | A | B | B |
| 1 | | test | alcohol | | | |
| | | | After immersion in | B | B | C |
| | | | alcohol containing | | | |
| | | | citric acid (pH: 3) | | | |

| | | | |
|---|---|---|---|
| Retort resistance (presence/ | A | A | B |
| absence of whitening) | | | |
| Adsorption of flavor components | D | C | D |
| Amount of extracted BPA [ppb] | N.D. | N.D. | N.D. |

In Tables 3 to 8, the abbreviations represent:

*1: NPES-629 (BPA epoxy resin available from NAN YA PLASTICS CORPORATION)

*2: MAA/St/EA=55/35/10 (the same monomer composition as that of (B)-1)

*3: MAA/MMA/EMA/BMA=60/15/10/15 (the same monomer composition as that of (B)-3)

*4: Phenodur PR612, phenol resin solution available from Allnex

*5: Cymel 303LF, amino resin available from Allnex

*6: Primid QM-1260, β-hydroxyalkylamide available from EMS Chemie

*7: Cymel NF2000, tris(alkoxycarbonylamino)triazine solution available from Allnex

In the tables, N.D. indicates that the target is not detected.

Tables 3 to 8 revealed that the coating films prepared from the aqueous coating compositions in Examples 1 to 34 and 16-2 to 16-7 which contained the composite resin (C) comprising the moiety of the epoxy resin (A), which is a reaction product of an epoxy compound not having any one of a bisphenol skeleton and a biphenol skeleton with a polyester, and the moiety of the carboxyl group-containing acrylate copolymer (B) all demonstrated reduced adsorption of the flavor components and had high retort resistance and bending processability. The aqueous coating composition in Comparative Example 1 demonstrated reduced adsorption of the flavor components and had favorable retort resistance and bending processability while elution of bisphenol A was observed.

### Inner Surface of Can Lid

### Example 101

### Preparation of Aqueous Coating Composition (Esterification)

An aqueous coating composition was prepared in the same manner as in Example 1 except that the solution of Acrylic copolymer (B-7) was used instead of Acrylic copolymer (B-1) and Epoxy resin (A-1) was reacted with Acrylic copolymer (B-7) at 80:20 (mass ratio), and was evaluated as follows.

The amount of dimethylaminoethanol was 40 mol % of the amount of methacrylic acid forming Acrylic copolymer (B-7).

### Preparation of Test Panel 2

Test panel 2 was prepared as follows: the aqueous coating composition prepared in Example 101 was applied onto an aluminum plate having a thickness of 0.26 mm with a bar coater such that the dry mass of the coating film after baking was 130 mg/dm², and then, was baked and dried by passing the workpiece through a double conveyor oven in 24 seconds, the oven including a first zone at a temperature of 286° C. and a second zone at a temperature of 326° C.

### Bending Processability

Test panel 2 prepared was evaluated for initial bending processability according to the current value based on the same criteria by the same method as those in the case of the coating for the inner surface of the can body in Example 1 and the like.

### Openability Test

Test panel 2 having a length of 50 mm and a width of 50 mm was prepared. A mold having a shape of a standard stay-on-tab for beverage cans was placed on the non-coated surface of the test panel, and was pressed with a press to form a portion to be an opening on the non-coated surface. The resulting test panel was used as a sample (test lid material).

Next, one end of the portion to be an opening was hit from the coated surface toward the non-coated surface with a rod-shaped tool to project the one end of the portion to be an opening with the aluminum plate to the non-coated surface side. One end of the portion to be an opening projected to the non-coated surface side was clamped with a pair of pliers, the aluminum plate was pulled off from the portion other than the portion to be an opening along the shape of the portion to be an opening to form an opening. The opening was visually determined in a view enlarged with a microscope.

Poor openability will cause the coating film to be left around the opening, and the width of the coating film projected into the opening will be increased. Favorable openability indicates that the coating film is not completely projected into the opening, or is very slightly projected if so. In a specific determination method, the width of the coating film projected was measured, and was evaluated according to the criteria for evaluation:

A: The maximum width of the projected coating film is less than 100 μm.

B: The maximum width of the projected coating film is 100 μm or more and less than 200 μm.

C: The maximum width of the projected coating film is 200 μm or more and less than 400 μm.

D: The maximum width of the projected coating film is 400 μm or more.

The lid of the beverage can is usually of the stay-on-tab, where the tab is forced into the can when the can is opened. However, because the openability of the coating film for the inner surface is more severely evaluated in the method of pulling off the tab from the can external, the evaluation in the present disclosure is performed as described above.

A result of evaluation “B” indicates that the coating film has favorable openability, and “A” indicates that the coating film has excellent openability. In contrast, “D” indicates poor openability.

### Retort Resistance Test

While Test panel 2 was immersed in water or an aqueous solution containing water or 2% by mass of citric acid having a pH of about 2, the test panel was subjected to a retort treatment in a retort tank at 125° C. for 30 minutes to visually evaluate the appearance of the coating film.

A: The coating film is not different from an untreated coating film.

B: The coating film is very slightly whitened.

C: The coating film is slightly whitened.

D: The coating film is remarkably whitened.

A result of evaluation “B” indicates that the coating film has favorable moisture resistance and acid resistance, and “A” indicates that the coating film has excellent moisture resistance and acid resistance. In contrast, “D” indicates poor moisture resistance and acid resistance.

### Adsorption of Flavor Components, Amount of Extracted BPA

Test panel 2 was evaluated for the adsorption of flavor components and the amount of extracted BPA based on the same criteria by the same method as those in the case of the coating for the inner surface of the can body in Example 1 and the like.

### Examples 102 to 107

### Preparation of Aqueous Coating Composition (Esterification)

Aqueous coating compositions were prepared in the same manner as in Example 101 by reacting the epoxy resin (A) with the acrylic copolymer (B) at 80:20 (mass ratio) except that Epoxy resins (A-2) to (A-7) were used instead of Epoxy resin (A-1).

### Examples 108 to 110

Aqueous coating compositions were prepared in the same manner as in Example 101 except that Epoxy resin (A-1) was reacted with Acrylic copolymer (B-7) at mass ratios of 85:15, 75:25, and 65:35, respectively. The amount of dimethylaminoethanol was 40 mol % of the amount of methacrylic acid forming Acrylic copolymer (B-7).

### Examples 111 and 112, Examples 113 and 114

Aqueous coating compositions were prepared in the same manner as in Example 101 by reacting the epoxy resin (A) with the acrylic copolymer (B) at 80:20 (mass ratio) except that instead of Epoxy resin (A-1), Epoxy resin (A-2) was used in Examples 111 and 112, and Epoxy resin (A-5) was used in Examples 113 and 114, and solutions of Acrylic copolymers (B-6) and (B-8) were used instead of the solution of Acrylic copolymer (B-7).

### Examples 115 and 116, Examples 117 and 118

Aqueous coating compositions were prepared in the same manner as in Examples 108 and 110 by reacting Epoxy resin (A-2) with Acrylic copolymer (B-6) or (B-7) at a mass ratio of 85:15 or 65:35 except that Epoxy resin (A-2) was used instead of Epoxy resin (A-1), a solution of Acrylic copolymer (B-6) was used in Examples 115 and 116, and a solution of Acrylic copolymer (B-7) was used in Examples 117 and 118.

### Examples 119 to 122

Aqueous coating compositions were prepared in the same manner as in Examples 115 to 118 by reacting Epoxy resin (A-5) with Acrylic copolymer (B-6) or Acrylic copolymer (B-7) at a mass ratio of 85:15 or 65:35 except that Epoxy resin (A-5) was used instead of Epoxy resin (A-2).

### Example 123

### Preparation of Aqueous Coating Composition (Grafting)

120 parts of Epoxy resin (A-5), 94.4 parts of diethylene glycol monobutyl ether, and 34.9 parts of butyl cellosolve were placed into a reaction container including a stirrer, a thermometer, a reflux cooling tube, a dropping tank, and a nitrogen gas introduction pipe, and were heated to 120° C., followed by stirring to completely dissolve the epoxy resin. While the inside of the reaction container was kept at 120° C., a solution of an acrylic monomer and a polymerization initiator prepared by mixing 18.0 parts of methacrylic acid, 4.0 parts of ethyl acrylate (ethyl acrylate), 6.0 parts of methyl methacrylate, 12.0 parts of butyl methacrylate, and 1.8 parts of benzoyl peroxide was added dropwise over 1 hour. After the addition was completed, the system was further kept at 120° C. for 1 hour, and was cooled to 90° C. to yield a composite resin. As a neutralizer, 10 parts of dimethylaminoethanol was added. Subsequently, 498.9 parts of deionized water was gradually added dropwise over 1 hour to prepare an aqueous coating composition having a solid content of 20.0%.

The mass ratio of Epoxy resin (A-5) to the acrylic monomer and the like fed to the reaction is 75:25.

### Example 124

### Preparation of Aqueous Coating Composition (Direct Method)

120 parts of Epoxy resin (A-7), 94.4 parts of diethylene glycol monobutyl ether, and 34.9 parts of butyl cellosolve were placed into a reaction container including a stirrer, a thermometer, a reflux cooling tube, a dropping tank, and a nitrogen gas introduction pipe, and were heated to 120° C., followed by stirring to completely dissolve the epoxy resin. While the inside of the reaction container was kept at 120° C., 0.6 parts of methacrylic acid and 0.004 parts of hydroquinone were placed thereinto, and 0.14 parts of a 25% sodium hydroxide aqueous solution was placed thereinto to perform a reaction for 3 hours.

The system was cooled to 90° C., and the temperature was kept. A solution of an acrylic monomer and a polymerization initiator prepared by mixing 17.4 parts of methacrylic acid, 4.0 parts of ethyl acrylate (ethyl acrylate), 6.0 parts of methyl methacrylate, 12.0 parts of butyl methacrylate, and 1.3 parts of benzoyl peroxide was added dropwise over 1 hour. The system was further kept at 90° C. for 1 hour to yield a composite resin, and was cooled to 60° C. As a neutralizer, 10 parts of dimethylaminoethanol was added. Subsequently, 499.3 parts of deionized water was gradually added dropwise over 1 hour to prepare an aqueous coating composition having a solid content of 20.0%.

The mass ratio of Epoxy resin (A-7) to the acrylic monomer and the like fed to the reaction is 75:25.

### Example 125

### Preparation of Aqueous Coating Composition (Grafting)

128 parts of Epoxy resin (A-2), 75.3 parts of diethylene glycol monobutyl ether, and 27.9 parts of butyl cellosolve were placed into a reaction container including a stirrer, a thermometer, a reflux cooling tube, a dropping tank, and a nitrogen gas introduction pipe, and were heated to 120° C., followed by stirring to completely dissolve the epoxy resin. While the inside of the reaction container was kept at 120° C., a solution of an acrylic monomer and a polymerization initiator prepared by mixing 16.0 parts of methacrylic acid, 8.0 parts of styrene, 8.0 parts of ethyl acrylate (ethyl acrylate), and 1.5 parts of benzoyl peroxide was added dropwise over 1 hour. After the addition was completed, the system was further kept at 120° C. for 1 hour, and was cooled to 90° C. to yield a composite resin. As a neutralizer, 6.6 parts of dimethylaminoethanol was added. Subsequently, 527.3 parts of deionized water was gradually added dropwise over 1 hour to prepare an aqueous coating composition having a solid content of 20.0%.

The mass ratio of Epoxy resin (A-2) to the acrylic monomer and the like fed to the reaction is 80:20.

### Example 126

### Preparation of Aqueous Coating Composition (Direct Method)

128 parts of Epoxy resin (A-4), 75.3 parts of diethylene glycol monobutyl ether, and 27.9 parts of butyl cellosolve were placed into a reaction container including a stirrer, a thermometer, a reflux cooling tube, a dropping tank, and a nitrogen gas introduction pipe, and were heated to 120° C., followed by stirring to completely dissolve the epoxy resin. While the inside of the reaction container was kept at 120° C., 0.8 parts of methacrylic acid and 0.004 parts of hydroquinone were placed thereinto, and 0.15 parts of a 25% sodium hydroxide aqueous solution was placed thereinto to perform a reaction for 3 hours.

The system was cooled to 90° C., and the temperature was kept. A solution of an acrylic monomer and a polymerization initiator prepared by mixing 15.2 parts of methacrylic acid, 8.0 parts of styrene, 8.0 parts of ethyl acrylate, and 1 part of benzoyl peroxide was added dropwise over 1 hour. The system was further kept at 90° C. for 1 hour to yield a composite resin, and was cooled to 60° C. As a neutralizer, 6.6 parts of dimethylaminoethanol was added. Subsequently, 527.7 parts of deionized water was gradually added dropwise over 1 hour to prepare an aqueous coating composition having a solid content of 20.0%.

The mass ratio of Epoxy resin (A-4) to the acrylic monomer and the like fed to the reaction is 80:20.

### Comparative Example 101

### Preparation of Aqueous Coating Composition (Esterification)

An aqueous coating composition having a solid content of 20.0% was prepared in the same manner as in Example 101 except that the type of raw materials and the composition in Example 101 was varied as shown in Table 11.

### Comparative Example 102 to Comparative Example 104

For convenience, in Comparative Examples 102 to 104, the coating compositions prepared in Comparative Examples 2 to 4 are evaluated as the aqueous coating compositions for the inner surface of the can.

TABLE 9

| Example | | | | | | | | | |
|---|---|---|---|---|---|---|---|---|---|
| 101 | 102 | 103 | 104 | 105 | 106 | 107 | 108 | 109 | 110 |

| | | | | | | | | | | |
|---|---|---|---|---|---|---|---|---|---|---|
| Composite | Epoxy resin (A) | Type of resin | (A)-1 | (A)-2 | (A)-3 | (A)-4 | (A)-5 | (A)-6 | (A)-7 | (A)-1 |

| | | | | | |
|---|---|---|---|---|---|
| resin | Mass ratio | 80 | 85 | 75 | 65 |

| | | | | |
|---|---|---|---|---|
| (C) | Acrylic copolymer (B) | Type of resin | (B)-7 | (B)-7 |

| | | | | |
|---|---|---|---|---|
| Mass ratio | 20 | 15 | 25 | 35 |

| | Method | | E method | | | | | | | E method | | |
|---|---|---|---|---|---|---|---|---|---|---|---|---|
| | E method: esterification | | | | | | | | | | | |
| | G method: grafting | | | | | | | | | | | |
| | D method: direct method | | | | | | | | | | | |
| Test | Bending processability | | A | A | B | A | A | A | A | A | A | B |
| panel | (initial) | | | | | | | | | | | |
| 2 | Openability | | A | A | A | B | A | B | A | B | A | A |
| | Retort resistance | Water | A | A | A | A | A | A | A | A | A | A |
| | (presence/absence | Citric acid-containing | B | B | B | B | A | A | A | B | B | B |
| | of whitening) | water (pH: 2) | | | | | | | | | | |

| | | | | | | | | | | |
|---|---|---|---|---|---|---|---|---|---|---|
| Adsorption of flavor components | A | B | A | B | A | A | A | A | A | A |
| Amount of extracted BPA [ppb] | N.D. | N.D. | N.D. | N.D. | N.D. | N.D. | N.D. | N.D. | N.D. | N.D. |

TABLE 10

| Example | | | | | | | | | | | |
|---|---|---|---|---|---|---|---|---|---|---|---|
| 111 | 112 | 113 | 114 | 115 | 116 | 117 | 118 | 119 | 120 | 121 | 122 |

| Composite | Epoxy resin (A) | Type of resin | (A)-2 | (A)-5 | (A)-2 | | | | (A)-5 | | | |
|---|---|---|---|---|---|---|---|---|---|---|---|---|
| resin | | Mass ratio | 80 | 80 | 85 | 65 | 85 | 65 | 85 | 65 | 85 | 65 |

| | | | | | | | | | | |
|---|---|---|---|---|---|---|---|---|---|---|
| (C) | Acrylic copolymer (B) | Type of resin | (B)-6 | (B)-8 | B)-6 | (B)-8 | (B)-6 | (B)-7 | (B)-6 | (B)-7 |

| | | | | | | | | | | |
|---|---|---|---|---|---|---|---|---|---|---|
| Mass ratio | 20 | 20 | 15 | 35 | 15 | 35 | 15 | 35 | 15 | 35 |

| | Method | | E method | | E method | | E method | | | | E method | | | |
|---|---|---|---|---|---|---|---|---|---|---|---|---|---|---|
| | E method: esterification | | | | | | | | | | | | | |
| | G method: grafting | | | | | | | | | | | | | |
| | D method: direct method | | | | | | | | | | | | | |
| Test | Bending processability | | A | A | A | A | A | B | A | B | A | B | A | B |
| panel | (initial) | | | | | | | | | | | | | |
| 2 | Openability | | A | A | A | A | B | A | B | A | B | A | B | A |
| | Retort resistance | Water | A | A | A | A | A | A | A | A | A | A | A | A |
| | (presence/absence | Citric acid-containing | B | B | A | A | B | B | B | B | A | A | A | A |
| | of whitening) | water (pH: 2) | | | | | | | | | | | | |

| | | | | | | | | | | | | |
|---|---|---|---|---|---|---|---|---|---|---|---|---|
| Adsorption of flavor components | B | B | A | A | B | A | B | A | A | A | A | A |
| Amount of extracted BPA [ppb] | N.D. | N.D. | N.D. | N.D. | N.D. | ND. | N.D. | N.D. | N.D. | N.D. | N.D. | N.D. |

TABLE 11

| | | | | | | | Comparative |
|---|---|---|---|---|---|---|---|
| | | | Example | | | | Example |
| | | | 123 | 124 | 125 | 126 | 101 |
| Composite | Epoxy resin (A) | Type of resin | (A)-5 | (A)-7 | (A)-2 | (A)-4 | *1 |
| resin | | Mass ratio | 75 | 75 | 80 | 80 | 80 |

| | | | | | |
|---|---|---|---|---|---|
| (C) | Acrylic copolymer (B) | Type of resin | *8 | *9 | (B)-7 |

| | | | | | |
|---|---|---|---|---|---|
| Mass ratio | 25 | 25 | 20 | 20 | 20 |

| | Method | | G | D | G | D | E |
|---|---|---|---|---|---|---|---|
| | E method: esterification | | method | method | method | method | method |
| | G method: grafting | | | | | | |
| | D method: direct method | | | | | | |
| Test | Bending processability | | A | A | A | A | A |
| panel | (initial) | | | | | | |
| 2 | Openability | | A | A | A | B | B |
| | Retort resistance (presence/ | Water | A | A | A | A | A |
| | absence of whitening) | Citric acid-containing | A | A | B | B | A |
| | | water (pH: 2) | | | | | |

| | | | | | |
|---|---|---|---|---|---|
| Adsorption of flavor components | A | A | B | B | A |
| Amount of extracted BPA [ppb] | N.D. | N.D. | N.D. | N.D. | 1.1 |

TABLE 12

| | | | Comparative Example | | |
|---|---|---|---|---|---|
| | | | 102 | 103 | 104 |
| | | | (2) | (3) | (4) |
| Test | Bending processability (initial) | | B | D | C |
| panel | Openability | | A | C | B |
| 2 | Retort resistance | Water | A | A | B |
| | (presence/absence | Citric acid-containing | B | A | C |
| | of whitening) | water (pH: 2) | | | |

| | | | |
|---|---|---|---|
| Adsorption of flavor components | D | C | D |
| Amount of extracted BPA [ppb] | N.D. | N.D. | N.D. |

In Tables 9 to 12, the abbreviations represent:

*1: NPES-629 (BPA epoxy resin available from NAN YA PLASTICS CORPORATION)

*8: MAA/EA/MMA/BMA=45/10/15/30 (the same monomer composition as that in (B)-7)

*9: MAA/St/EA=50/25/25 (the same monomer composition as that in (B)-6)

In the tables, N.D. indicates that the target is not detected.

Tables 9 to 12 reveal that the coating films prepared from the aqueous coating compositions in Examples comprising the composite resin (C) including the moiety of the epoxy resin (A), which is a reaction product of the epoxy compound not having a bisphenol skeleton and the like with the polyester, and the moiety of the carboxyl group-containing acrylate copolymer (B) all demonstrated reduced adsorption of the flavor components and had high retort resistance and bending processability. The aqueous coating composition in Comparative Example 101 demonstrated reduced adsorption of the flavor components and had high retort resistance and bending processability while elution of bisphenol A was observed.

### Coating for Outer Surface of Can Lid

### Examples 102-2, 105-2, 123-2 to 126-2 and Comparative Example 101-2

Carnauba wax and polyethylene wax each were added in an amount of 2 parts by mass in terms of solid content relative to 100 parts by mass of the corresponding composite resin contained in the aqueous coating compositions in Examples 102, 105, 123 to 126 and Comparative Example 101 to prepare aqueous coating compositions for the outer surface, and the resulting aqueous coating compositions were evaluated by the following method.

### Preparation of Test Panel 3

A test panel was prepared as follows: The aqueous coating composition for the outer surface containing the waxes was applied onto an aluminum plate having a thickness of 0.26 mm with a bar coater such that the dry mass of the coating film after baking was 45 mg/dm², and then, was baked and dried by passing the workpiece through a double conveyor oven in 24 seconds, the oven including a first zone at a temperature of 286° C. and a second zone at a temperature of 326° C.

### Coefficient of Kinetic Friction

A 1 kg weight provided with three steel balls was placed on the coating film surface of Test panel 3 such that the steel balls were in contact with the coating film surface, and the weight was pulled at a rate of 150 cm/min. The coefficient of kinetic friction at this time was measured. A smaller coefficient of kinetic friction indicates better slip properties.

### Resistance to Wear

Using Tribogear HEIDON-22H (Shinto Scientific Co., Ltd.), a stainless steel ball with a contact maker having a diameter of 3 mm was reciprocally moved on Test panel 3 at a load of 1000 g, a travel width of 2 mm, and a travel rate of 300 mm/min. The number of travels until scratches occurred in the coating film and reached the aluminum substrate was measured.

A: The number of travels is 1000 or more.

B: The number of travels is 500 or more and less than 1000.

C: The number of travels is 200 or more and less than 500.

D: The number of travels is less than 200.

A result of evaluation “B” indicates favorable resistance to wear, and “A” indicates high resistance to wear. In contrast, “D” indicates poor resistance to wear.

### Retort Resistance Test

Similarly to the evaluation of the can body member, while Test panel 3 was immersed in water, the test panel was subjected to a retort treatment in a retort tank at 125° C. for 30 minutes, and the appearance of the coating film was visually evaluated.

A: The coating film is not different from an untreated coating film.

B: The coating film is very slightly whitened

C: The coating film is slightly whitened.

D: The coating film is remarkably whitened.

A result of evaluation “B” indicates that the coating film has favorable moisture resistance and acid resistance, and “A” indicates that the coating film has excellent moisture resistance and acid resistance. In contrast, “D” indicates poor moisture resistance and acid resistance.

### Adhesion (Cross-Cut Peeling Test)

The coating film of Test panel 1 was cut with a cutter such that 11 scratches orthogonal to each other at an interval of 1 mm reached the substrate. While the resulting test panels were immersed in water or an aqueous solution containing citric acid having a pH of about 2, the test panels were subjected to a retort treatment in a retort tank at 125° C. for 30 minutes, and were spontaneously cooled to around 23° C. The resulting products were used as test pieces for evaluation of adhesion.

A cellophane tape was tightly applied to the scratches of the test pieces, and was peeled to observe the peel state of the coating film.

A: no peel

B: less than 5% of peel is observed

C: 5 to 20% of peel is observed

D: more than 20% of peel is observed

A result of evaluation “B” indicates that the coating film has favorable adhesion, and “A” indicates that the coating film has excellent adhesion. In contrast, “D” indicates poor adhesion.

TABLE 13

| | | | | | | | | | Comparative |
|---|---|---|---|---|---|---|---|---|---|
| | | | Example | | | | | | Example |
| | | | 102-2 | 105-2 | 123-2 | 124-2 | 125-2 | 126-2 | 101-2 |
| Composite | Epoxy resin (A) | Type of resin | (A)-2 | (A)-5 | (A)-5 | (A)-7 | (A)-2 | (A)-4 | *1 |
| resin | | Mass ratio | 80 | | 75 | 75 | 80 | 80 | 80 |
| (C) | Acrylic copolymer (B) | Type of resin | (B)-7 | | *8 | | *9 | | (B)-7 |
| | | Mass ratio | 20 | | 25 | 25 | 20 | 20 | 20 |
| | Method | | E method | | G method | D method | G method | D method | E method |
| | E method: esterification | | | | | | | | |
| | G method: grafting | | | | | | | | |
| | D method: direct method | | | | | | | | |
| WAX | Carnauba wax | Mass ratio | 2 | 2 | 2 | 2 | 2 | 2 | 2 |
| | Polyethylene wax | Mass ratio | 2 | 2 | 2 | 2 | 2 | 2 | 2 |

| | | | | | | | | |
|---|---|---|---|---|---|---|---|---|
| Test | Coefficient of | 0.07 | 0.06 | 0.06 | 0.07 | 0.07 | 0.07 | 0.07 |
| panel | kinetic friction | | | | | | | |
| 3 | Resistance to wear | A | A | A | A | A | A | A |
| | Retort resistance (presence/ | A | A | A | A | A | A | A |
| | absence of whitening) | | | | | | | |
| | Adhesion | A | A | A | A | A | A | A |

In Table 13, the abbreviations represent:

*1: NPES-629 (BPA epoxy resin available from NAN YA PLASTICS CORPORATION)

*8: MAA/EA/MMA/BMA=45/10/15/30 (the same monomer composition as that in (B)-7)

*9: MAA/St/EA=50/25/25 (the same monomer composition as that in (B)-6)

Table 13 reveals that the coating films prepared from the aqueous coating compositions containing the waxes in Examples 102-2, 105-2, and 123-2 to 126-2 all demonstrated favorable physical properties as in the aqueous coating composition in Comparative Example 101-2 comprising a conventional epoxy resin having a bisphenol skeleton.

This application claims priority based on Japanese Patent Application No. 2018-77723 filed on Apr. 13, 2018, and Japanese Patent Application No. 2018-220430 filed on Nov. 26, 2018, the entire contents of which are hereby incorporated by reference.

### REFERENCE SIGNS LIST

1 test panel

2 rod

3 test piece

4 weight

10 can

11 can member

12 coating film

1-7. (canceled)

8. An aqueous coating composition comprising:
a composite resin; and
water,
wherein the composite resin includes a moiety of an epoxy resin and a moiety of a carboxyl group-containing acrylate copolymer, and
the epoxy resin forming the moiety of the epoxy resin is a reaction product of an epoxy group in an epoxy compound not having any one of a bisphenol skeleton and a biphenol skeleton with a carboxyl group in a polyester having a carboxyl group, the reaction product having an epoxy group.

9. The aqueous coating composition according to claim 8,
wherein the epoxy compound is an epoxy compound having
a unit selected from the group consisting of linear hydrocarbon units, oxyalkylene units, cyclic hydrocarbon units, and heterocycle units other than an epoxy group, and
two glycidyl groups.

10. The aqueous coating composition according to claim 8,
wherein the epoxy resin has an epoxy equivalent of 200 or more and 200,000 or less.

11. The aqueous coating composition according to claim 8,
wherein the composite resin is a composite resin having the moiety of the acrylate copolymer in at least one of terminals of the moiety of the epoxy resin.

12. The aqueous coating composition according to claim 8,
wherein the composite resin is a graft polymer having the moiety of the acrylate copolymer in a side chain of the moiety of the epoxy resin.

13. A member for a can comprising:
a coating film of the aqueous coating composition according to claim 8 on a surface of a can substrate.

14. A can comprising a plurality of members for a can which form the can, the plurality of members for a can at least partially including a member for a can according to claim 13.
